(19) United States
(12) Patent Application Publication
(10) Pub. No.: US 2021/0388609 A1
(43) Pub. Date: Dec. 16, 2021

(54) MODULAR CONSTRUCTION OF LOAD-BEARING STRUCTURES FROM REUSABLE LOAD-BEARING ELEMENTS

(71) Applicant: THE REGENTS OF THE UNIVERSITY OF MICHIGAN, Ann Arbor, MI (US)

(72) Inventor: Victor C. LI, Ann Arbor, MI (US)

(73) Assignee: THE REGENTS OF THE UNIVERSITY OF MICHIGAN, Ann Arbor, MI (US)

(21) Appl. No.: 17/292,185

(22) PCT Filed: Nov. 8, 2019
(86) PCT No.: PCT/US2019/060552

§ 371 Date: May 7, 2021

Related U.S. Application Data
(60) Provisional application No. 62/757,307, filed on Nov. 8, 2018.

(51) Int. Cl. E04B 2/18; E04B 5/08; E04B 5/00; E01D 19/12

(52) U.S. Cl. CPC E04B 2/18; E04B 5/08; E04B 2002/0221; E01D 19/125; E04C 1/24

(57) ABSTRACT

A new civil infrastructure construction scheme is provided that is capable of meeting various objectives, including reducing climate change, addressing labor shortage issues, and enhancing construction productivity. Methods of forming load-bearing structures include placing a first reusable load-bearing element adjacent to a second reusable load-bearing element. The first reusable load-bearing element is fixed with respect to the second reusable load-bearing element without any adhesive or mortar. The first reusable load-bearing element and the second reusable load-bearing element respectively have a compressive strength of greater than or equal to about 25 MPa. The first and second reusable load-bearing elements optionally may be formed by additive manufacturing with a printable cementitious composition, such as an engineered cementitious composite.

### CROSS-REFERENCE TO RELATED APPLICATIONS

This application claims the benefit of U.S. Provisional Application No. 62/757,307, filed on Nov. 8, 2018. The entire disclosure of the above application is incorporated herein by reference.

### FIELD

The present disclosure relates to modular construction of load-bearing structures for civil infrastructure with reusable building module units.

### BACKGROUND

This section provides background information related to the present disclosure which is not necessarily prior art.

The construction industry faces a variety of challenges. These include a shortage of skilled labor, declining construction productivity, and increasing concerns for negative impact of construction activities on the natural environment. There are worldwide trends seeking greener or more environmentally friendly construction and transforming civil infrastructure construction to a process that more closely mirrors that of streamlined manufacturing of goods. While construction is full of highly repeatable processes, the majority of construction projects are still treated as one-off prototypes and started from scratch manually, thus sacrificing time and cost efficiencies.

In concrete construction, there are two main approaches: cast-in-place and precast. In general, the precast approach is more efficient than the cast-in-place approach, which has a restricted casting sequence that limits the construction efficiency. For instance, in a bridge construction, the piers must be cast and gain sufficient mechanical strength, before the girders can be cast. In precast construction, different structural components can be fabricated offsite and in parallel and rapidly installed in the field. Precast construction has shown great success in accelerated bridge construction and modular construction for the housing market, both improving the construction productivity, safety, and economic and environmental benefits, due to the use of prefabricated components.

While there are currently prefabricated and precast structures and modular construction for buildings, these current techniques also suffer from major limitations, including, but not limited to: (a) being time consuming, labor-intensive, and requiring on-site assembly and jointing; (b) being used for custom or one-of-a-kind construction project; (c) formed of construction materials that are not generally designed for disassembly or reconfiguration from one structural type to another; and (d) forming architecturally and aesthetically unappealing structures (e.g., stacked containers).

Despite the success, the current precast construction practices face limitations. (1) The designs of structures limit the construction efficiency. Construction is time consuming, labor-intensive, and requires on-site assembly and jointing. Current prefabricated elements are connected using wet joints (fresh grouts), which need time to cure. The limited construction efficiency aggravates traffic congestion, compromising the mobility, economic benefits, and quality of life. Traffic delays costs billions of dollars in wasted gas and person hours per year, without considering the adverse effects on the environment and human health. (2) Current structures cannot be reused, generating a large amount of construction and demolishment (C&D) wastes. Thus, current prefabricated elements are formed of construction materials that are not generally designed for disassembly or reconfiguration from one structural type to another. Although concrete may be recycled, the recycling process involves multiple treatment stages such as sorting, crushing, and cleaning, thus increasing the cost, carbon and energy footprints. In practice, recycled concrete is used as a lower grade concrete compared with normal concrete. The recycling rate of C&D wastes is limited. While roads and bridges annually produce more than 150 million tons of concrete waste in the U.S., less than 40% is recycled. The remaining portion is disposed through landfill, but the area available for landfills is shrinking. (3) The majority of precast structures use unique prefabricated elements that are not exchangeable among different structures, and the construction process cannot be standardized and use of construction robots realized. High demand of skilled labor and low adoption of robotic systems limit the construction productivity. (4) The precast structures are less architecturally and aesthetically attractive. For instance, modular construction delivers stereotypical bulky boxes (e.g., stacked containers).

There is a need for innovative solutions that improve construction efficiency, mobility, resilience, aesthetics, and sustainability. It would be desirable to have a modular construction system that provides streamlined construction with reusable load-bearing materials. Furthermore, it would be desirable for the modular construction system to include durable damage-resistant materials for the modular units, rapid jointing technology, robotics for assembly and disassembly, and structural serviceability and safety of the load-bearing structures formed therefrom. It would be desirable to create a finite set of universal modular units that can be jointed into different types of load-bearing structures. In other words it would be desirable to have a modular construction system, where an assembled structure can be disassembled and reconfigured into a different structure if desired, thus reusing the modular units without waste. This “reuse” is economically and environmentally more desirable than “recycling” and “downgrading the use” of materials.

### SUMMARY

This section provides a general summary of the disclosure, and is not a comprehensive disclosure of its full scope or all of its features.

In various aspects, the present disclosure provides a method of forming a load-bearing structure. In certain aspects, the method comprises forming the load-bearing structure by placing a first reusable load-bearing element adjacent to a second reusable load-bearing element. The first reusable load-bearing element is fixed with respect to the second reusable load-bearing element without adhesive or mortar. Further, the first reusable load-bearing element and the second reusable load-bearing element respectively have a compressive strength of greater than or equal to about 25 MPa.

In one aspect, the placing is an automated process.

In one aspect, the load-bearing structure is a civil infrastructure component.

In one aspect, the load-bearing structure is selected from the group consisting of: a building, a bridge, a roadway, a runway, a retaining wall, a sound barrier wall, a hydraulic structure, a tunnel, and combinations thereof.

In one aspect, the forming further comprises coupling the first reusable load-bearing element to the second reusable load-bearing element after the placing.

In one further aspect, the coupling comprises mechanically fastening the first reusable load-bearing element to the second reusable load-bearing element.

In one aspect, the load-bearing structure is a first load-bearing structure and the method further comprises dissembling the load-bearing structure and forming a second load-bearing structure from at least one of the first reusable load-bearing element and the second reusable load-bearing element.

In one aspect, the first reusable load-bearing element and the second reusable load-bearing element each comprise a cementitious material substantially free of any metal reinforcement components.

In one aspect, the load-bearing structure is substantially free of any metal reinforcement components.

In one aspect, the load-bearing structure is post-tensioned after assembly. Thus, after forming, the load-bearing structure is tensioned with a tensioning component that is capable of disassembly.

In one aspect, the first reusable load-bearing element and the second reusable load-bearing element are a portion of a plurality of reusable load-bearing elements that are assembled to form the load-bearing structure.

In one aspect, the method further comprises forming the first reusable load-bearing element and the second reusable load-bearing element by additive manufacturing with a printable cementitious composition having a fresh state and a hardened state. In the fresh state, the printable cementitious composition is flowable and extrudable in the additive manufacturing process and in the hardened state, the printable cementitious composition exhibits strain hardening. The printable cementitious composition comprises Portland cement, a calcium aluminate cement, a fine aggregate, water, a high range water reducing agent (HRWRA), and a polymeric fiber.

In one further aspect, the first reusable load-bearing element and the second reusable load-bearing element respectively have a hardened state with a compressive strength at 28 days of greater than or equal to about 25 MPa.

In one further aspect, the first reusable load-bearing element and the second reusable load-bearing element have a uniaxial tensile strength of greater than or equal to about 2.5 MPa and a tensile strain capacity of greater than or equal to about 1%.

In one further aspect, the forming further comprises depositing the printable cementitious composition in a fresh state by passing the printable cementitious composition through an aperture to deposit the cementitious composition onto a target. In the fresh state the composition is flowable and extrudable and after the depositing, the cementitious composition forms a hardened state exhibiting a uniaxial tensile strength of greater than or equal to about 2.5 MPa, a tensile strain capacity of greater than or equal to about 1%, and a compressive strength at 100 hours of greater than or equal to about 20 MPa.

In one aspect, the first reusable load-bearing element and the second reusable load-bearing element comprise an engineered geopolymer composite cementitious composition comprising fly ash, a fine aggregate, sodium silicate (Na₂SiO₃), sodium hydroxide (NaOH), a polymeric fiber, and water.

In one further aspect, the engineered geopolymer composite cementitious composition comprises the fine aggregate present at greater than or equal to about 17 to less than or equal to about 22 mass % of the cementitious composition, the fly ash present at greater than or equal to about 50 to less than or equal to about 60 mass % of the cementitious composition, water is present at greater than or equal to about 7 to less than or equal to about 12 mass % of the cementitious composition, the polymeric fiber is present at greater than or equal to about 0.7 to less than or equal to about 1.5 mass % of the cementitious composition, sodium silicate (NaSiO₃) present at greater than or equal to about 10 to less than or equal to about 15 mass % of the cementitious composition, and sodium hydroxide (NaOH) present at greater than or equal to about 2.5 to less than or equal to about 3.5 mass % of the cementitious composition.

In one aspect, the first reusable load-bearing element and the second reusable load-bearing element respectively have at least one dimension that is greater than or equal to about 1 meter.

In one aspect, the first reusable load-bearing element and the second reusable load-bearing element respectively have a first dimension of greater than or equal to about 0.3 meters (about 1 foot), a second dimension of greater than or equal to about 1 meter (about 3 feet), and a third dimension of greater than or equal to about 2 meters (about 6 feet).

In one aspect, the first reusable load-bearing element comprises a first mechanical interlock feature and the second reusable load-bearing element comprises a second mechanical interlock feature. The first mechanical interlock feature is configured to be complementary to the second mechanical interlock feature.

In one aspect, at least one of the first reusable load-bearing element and the second reusable load-bearing element comprises an integrally formed feature.

In one aspect, the load-bearing structure has a lifetime of greater than or equal to about 50 years in an external environment.

In one aspect, the method further comprises disassembling the first reusable load-bearing element and the second reusable load-bearing element. The first reusable load-bearing element and the second reusable load-bearing element are reassembled without adhesive or mortar to form a second distinct load-bearing structure.

In various other aspects, the present disclosure provides a modular building system that comprises a first reusable load-bearing component. The first reusable load-bearing component comprises a first cementitious composition and has at least one first interlock feature defining either a protrusion or a recess. The first reusable load-bearing component also includes at least one first aperture defined through a first wall. The modular building system also includes a second reusable load-bearing component comprising a second cementitious composition and having at least one second interlock feature complementary to the first interlock feature having the other of the protrusion or the recess. The second reusable load-bearing component has at least one second aperture defined through a second wall. The first wall and the second wall are adjacent to one another so that the at least one first interlock feature seats against the second interlock feature. The modular building system also comprises a fastener disposed in the first aperture and the second aperture that secures the first reusable load-bearing component and the second reusable load bearing component together without any adhesive or mortar.

In one aspect, the first reusable load-bearing element and the second reusable load-bearing element respectively have a compressive strength of greater than or equal to about 25 MPa.

In one aspect, the first reusable load-bearing element and the second reusable load-bearing element have a uniaxial tensile strength of greater than or equal to about 2.5 MPa and a tensile strain capacity of greater than or equal to about 1%.

In one aspect, the first cementitious composition and the second cementitious composition comprise Portland cement, a calcium aluminate cement, a fine aggregate, water, a high range water reducing agent (HRWRA), and a polymeric fiber.

In one further aspect, the first cementitious composition and the second cementitious composition comprise the Portland cement at greater than or equal to about 25 mass % to less than or equal to about 40 mass % of the total mass of the composition, calcium aluminate cement at greater than or equal to about 1 mass % to less than or equal to about 4 mass %, the fine aggregate at greater than or equal to about 18 mass % to less than or equal to about 35 mass %, water at greater than or equal to about 18 mass % to less than or equal to about 30 mass %, the high range water reducing agent (HRWRA) at greater than or equal to about 0.2 mass % to less than or equal to about 0.6 mass %, and the polymeric fiber is present at greater than or equal to about 0.7 mass % to less than or equal to about 2.1 mass % of the total mass of the first cementitious composition or the second cementitious composition.

In one further aspect, the fine aggregate comprises sand having an average particle size of less than or equal to about 2 mm.

In one further aspect, the polymer fiber comprises polyvinyl alcohol (PVA).

In one further aspect, the polymer fiber has a length of greater than or equal to about 5 mm to less than or equal to about 20 mm.

In one further aspect, wherein the first cementitious composition and the second cementitious composition further comprise one or more of: fly ash, silica flour, microsilica, attapulgite nanoclay, and hydroxypropylmethyl cellulose (HPMC).

In one further aspect, each respective first cementitious composition and second cementitious composition comprises Portland cement at greater than or equal to about 25 mass to less than or equal to about 40 mass %, calcium aluminate cement at greater than or equal to about 1 mass % to less than or equal to about 4 mass %, the fine aggregate at greater than or equal to about 18 mass % to less than or equal to about 38 mass %, water at greater than or equal to about 18 mass % to less than or equal to about 35 mass %, the high range water reducing agent (HRWRA) at greater than or equal to about 0.2 mass % to less than or equal to about 0.6 mass %, the polymeric fiber at greater than or equal to about 0.7 mass % to less than or equal to about 2.2 mass %, fly ash at greater than or equal to about 5 mass % to less than or equal to about 15 mass %, silica flour at greater than or equal to about 0.1 mass % to less than or equal to about 5.0 mass %, microsilica at greater than or equal to about 2.0 mass % to less than or equal to about 8.0 mass %, attapulgite nanoclay at greater than or equal to about 0.1 mass % to less than or equal to about 5.0 mass %, hydroxypropylmethyl cellulose (HPMC) at greater than or equal to about 0.05 mass % to less than or equal to about 0.5 mass % of the total mass of the cementitious composition.

In one aspect, each respective first cementitious composition and second cementitious composition comprises an engineered geopolymer composite cementitious composition comprising a fly ash, a fine aggregate, sodium silicate (Na₂SiO₃), sodium hydroxide (NaOH), a polymeric fiber, and water.

In one further aspect, the engineered geopolymer composite cementitious composition comprises the fine aggregate present at greater than or equal to about 17 to less than or equal to about 22 mass % of the cementitious composition, the fly ash present at greater than or equal to about 50 to less than or equal to about 60 mass % of the cementitious composition, water is present at greater than or equal to about 7 to less than or equal to about 12 mass % of the cementitious composition, the polymeric fiber is present at greater than or equal to about 0.7 to less than or equal to about 1.5 mass % of the cementitious composition, the sodium silicate (NaSiO₃) present at greater than or equal to about 10 to less than or equal to about 15 mass % of the cementitious composition, and the sodium hydroxide (NaOH) present at greater than or equal to about 2.5 to less than or equal to about 3.5 mass % of the cementitious composition.

In one aspect, the first reusable load-bearing component defines a rectangular prism having a hollow central region. The second reusable load-bearing element has a shape selected from the group consisting of: a rectangular prism having a hollow central region, a female plate component, a male plate component, and combinations thereof.

In one aspect, the first reusable load-bearing component defines a rectangular prism having a hollow central region having a first volume. The second reusable load-bearing element defines a rectangular prism having a hollow central region and a second volume smaller than the first volume.

In one further aspect, the modular building system further comprises a third reusable load-bearing component defining a female plate component and a fourth reusable load-bearing component defining a male plate component.

In one aspect, the first interlock feature defines a protrusion having a truncated tapered cylinder shape and the second interlock feature defines a recess defining a complementary truncated tapered cylinder shape.

In various other aspects, the present disclosure provides a load-bearing structure comprising a plurality of first reusable load-bearing components. The plurality of first reusable load-bearing components comprises a first cementitious composition and each has at least one first interlock feature defining either a protrusion or a recess and at least one first aperture defined through a first wall. The load-bearing structure also comprises a plurality of second reusable load-bearing components comprising a second cementitious composition. The plurality of second reusable load-bearing components each have at least one second interlock feature complementary to the first interlock feature having the other of the protrusion or the recess. Further, each of the plurality of second reusable load-bearing components includes at least one second aperture defined through a second wall. Each respective first wall and second wall are adjacent to one another so that the at least one first interlock feature seats against the second interlock feature. The load-bearing structure also comprises a plurality of fasteners respectively disposed in the first aperture and the second aperture that secures each of the first reusable load-bearing component and the second reusable load bearing components together without any adhesive or mortar.

In one aspect, the load-bearing structure is selected from the group consisting of: a building, a bridge, a roadway, a runway, a retaining wall, a sound barrier wall, a hydraulic structure, a tunnel, and combinations thereof.

In one aspect, the plurality of first reusable load-bearing elements and the plurality of second reusable load-bearing elements each respectively has a compressive strength of greater than or equal to about 25 MPa.

In one aspect, the plurality of first reusable load-bearing elements and the plurality of second reusable load-bearing elements each has a uniaxial tensile strength of greater than or equal to about 2.5 MPa and a tensile strain capacity of greater than or equal to about 1%.

In one aspect, each respective first cementitious composition and second cementitious composition comprises Portland cement, a calcium aluminate cement, a fine aggregate, water, a high range water reducing agent (HRWRA), and a polymeric fiber.

In one aspect, each respective first cementitious composition and second cementitious composition comprises an engineered geopolymer composite cementitious composition comprising a fly ash, a fine aggregate, sodium silicate (Na₂SiO₃), sodium hydroxide (NaOH), a polymeric fiber, and water.

In one aspect, the plurality of first reusable load-bearing components defines a rectangular prism having a hollow central region. The plurality of second reusable load-bearing elements has a shape selected from the group consisting of: a rectangular prism having a hollow central region, a female plate component, a male plate component, and combinations thereof.

In one aspect, the first reusable load-bearing component defines a rectangular prism having a hollow central region having a first volume, the second reusable load-bearing element defines a rectangular prism having a hollow central region and a second volume smaller than the first volume, and the load-bearing structure further comprises a plurality of third reusable load-bearing components defining a female plate component, and a plurality of fourth reusable load-bearing components defining a male plate component.

In one aspect, the load-bearing structure further comprises at least one tensioning component connected to the assembly of the plurality of first reusable load-bearing components and the plurality of second reusable load-bearing components.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a simplified sectional view of an example of a load-bearing structure formed from a plurality of reusable load-bearing elements in accordance with certain aspects of the present disclosure.

FIG. 2 is schematic flow chart showing a non-limiting example of a lifecycle for making and disassembling a load-bearing structure according to certain aspects of the present disclosure.

FIGS. 3A-3D show reusable load-bearing components for a modular construction system according to certain variations of the present disclosure. FIG. 3A shows a full size reusable load-bearing component having a rectangular prism shape with a hollow interior. FIG. 3B shows a half-size reusable load-bearing component having a rectangular prism shape with a hollow interior. FIG. 3C shows a reusable load-bearing component in the form of a male plate component with protrusions. FIG. 3C shows a reusable load-bearing component in the form of a female plate component with recesses.

FIG. 4 shows a partially assembled modular building system incorporating a plurality of distinct reusable load-bearing components according to certain aspects of the present disclosure.

FIG. 5 shows a fully assembled modular building system incorporating a plurality of distinct reusable load-bearing components according to certain aspects of the present disclosure.

FIG. 6 shows a detailed view of a first terminal end of a fully assembled modular building system incorporating a plurality of distinct reusable load-bearing components according to certain aspects of the present disclosure.

FIG. 7 shows a detailed view of a second terminal end of a fully assembled modular building system incorporating a plurality of distinct reusable load-bearing components according to certain aspects of the present disclosure.

FIG. 8 shows a different view of a fully assembled modular building system incorporating a plurality of distinct reusable load-bearing components according to certain aspects of the present disclosure having a plurality of fasteners in longitudinal and latitudinal directions.

FIGS. 9A-9C. FIG. 9A shows dimensions of a representative dog-bone specimen in mm. FIG. 9B shows a testing device used to test physical properties of the dog-bone specimen in FIG. 9A and FIG. 9C shows a cross-sectional view of the specimen tested.

FIG. 10 shows an assembly order for a plurality of reusable load-bearing components that form a footbridge load-bearing structure in accordance with certain aspects of the present disclosure.

FIG. 11 shows a test setup of a footbridge load-bearing structure formed from a plurality of reusable load-bearing components in accordance with certain aspects of the present disclosure.

FIG. 12 shows a test setup of a load-bearing building frame formed from a plurality of reused and disassembled load-bearing components that originally formed the footbridge in FIG. 11.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

To meet climate change, labor shortage, and construction productivity challenges, the present disclosure provides a new civil infrastructure construction scheme. In certain aspects, the present disclosure provides a method of forming a load-bearing structure that comprises forming the load-bearing structure by placing a plurality of reusable load-bearing elements in a distinct predetermined arrangement with respect to one another to define the desired load-bearing structure. For example, in certain aspects, the present disclosure provides a method of forming a load-bearing structure that comprises forming the load-bearing structure by placing a first reusable load-bearing element or module adjacent to a second reusable load-bearing element or module. After the placement, the first reusable load-bearing element is fixed with respect to the second reusable load-bearing element. As discussed further below, when desired, for example at the end of service life, the load-bearing elements can be unfixed or separated from one another so that they are separate and distinct elements that are fully reusable, including in a potentially new configuration.

In certain aspects, the first reusable load-bearing element and the second reusable load-bearing element are robust, high-strength elements or modules capable of being used to build a load-bearing structure for use in civil infrastructure. A load-bearing structure is one that complies with appropriate standards and/or building codes for civil infrastructure or construction in a municipality to form a specific civil infrastructure structure. Thus, in certain aspects, the load-bearing structure is civil infrastructure (e.g., a component for forming civil infrastructure). By way of non-limiting example, the load-bearing structure may be selected from the group consisting of: a building (such as a house, a multiunit dwelling, a skyscraper, commercial facility, industrial facility, aviation, rail, nautical, or power facilities, and the like), a bridge, a roadway, a runway, a retaining wall (e.g., an earth retaining wall), a sound barrier wall, a hydraulic structure, a tunnel, and combinations thereof. Such a load-bearing structure desirably can withstand one or more of the following: wind loads, seismic (earthquake) loads, or flooding (storm surge) loads. In certain non-limiting aspects, the load-bearing structure may comply with standards set forth in American Concrete Institute (ACI) 318 “Building Code Requirements for Structural Concrete and Commentary” or American Association of State Highway and Transportation Officials (AASHTO) Specifications for Transportation Infrastructure, by way of example.

Each reusable load-bearing element may have a compressive strength of greater than or equal to about 25 MPa, optionally greater than or equal to about 30 MPa, optionally greater than or equal to about 30 MPa, optionally greater than or equal to about 35 MPa, optionally greater than or equal to about 40 MPa, optionally greater than or equal to about 45 MPa, and in certain aspects, optionally greater than or equal to about 50 MPa.

In certain aspects, the load-bearing structure is robust and durable, for example, having a lifetime of greater than or equal to about 12 months (1 year) in an external environment, where it is exposed to various environmental elements, including precipitation, wind, groundwater, bodies of water, and other environmental factors, including pollution. In certain aspects, the lifetime of the load-bearing structure may be greater than or equal to about 18 months (1.5 years), optionally greater than or equal to about 2 years, optionally greater than or equal to about 3 years, optionally greater than or equal to about 4 years, optionally greater than or equal to about 5 years, optionally greater than or equal to about 6 years, optionally greater than or equal to about 7 years, optionally greater than or equal to about 8 years, optionally greater than or equal to about 9 years, optionally greater than or equal to about 10 years, optionally greater than or equal to about 15 years, optionally greater than or equal to about 20 years, optionally greater than or equal to about 25 years, optionally greater than or equal to about 30 years, optionally greater than or equal to about 35 years, optionally greater than or equal to about 40 years, optionally greater than or equal to about 45 years, optionally greater than or equal to about 50 years, optionally greater than or equal to about 55 years, optionally greater than or equal to about 60 years, optionally greater than or equal to about 65 years, optionally greater than or equal to about 70 years, optionally greater than or equal to about 75 years, optionally greater than or equal to about 80 years, optionally greater than or equal to about 85 years, optionally greater than or equal to about 90 years, optionally greater than or equal to about 95 years, and in certain variations, optionally greater than or equal to about 100 years. In certain aspect, the load-bearing structure has a lifetime ranging from greater than or equal to about 50 years to at least about 100 years.

By “reusable,” it is meant that a plurality of the load-bearing elements may be used to form an initial load-bearing structure and then may be disassembled from the initial load-bearing structure and reconfigured to form a second load-bearing structure. In contrast to typical modular construction materials that may be used only once and then discarded or transformed by recycling into a secondary and distinct use, the load-bearing elements of the present teachings remain intact and reusable and capable of load-bearing after disassembly from the initial structure. After disassembly, the load-bearing elements remain structurally sound, such that they can be reused as a structural element in a subsequent structure. Thus, each load-bearing element may have a lifetime corresponding to those specified above for the load-bearing structures and in certain aspects, the lifetime of each load-bearing element may be longer than the lifetime of the load-bearing structure that the load-bearing element is used initially to form. The initial load-bearing structure and second load-bearing structure may be the same type of structure, for example, a first building and a second building or may be different structures, for example, a building and a roadway. In this manner, the load-bearing elements are reused and upcycled, therefore, providing a low waste and environmentally friendly or green construction process.

In certain aspects, each reusable load-bearing element may be a monolithic or integrally formed structure. The reusable load-bearing element may be free of any joints. In certain aspects, the reusable load-bearing element may be a molded or formed via additive manufacturing (e.g., a three-dimensionally printed structure). In this manner, the reusable load-bearing element may be a solid structure, such as a solid block, or may be a structure having one or more void or hollow regions defined internally. The reusable load-bearing elements may have complementary shapes with one another that form complementary surfaces that nest, mate, or seat with one another to form a closed interface, for example, a substantially sealed or weather tight joint. The reusable load-bearing elements may have rectangular or other more complex shapes that permit modular assembly to form the load-bearing structure with the desired shape or footprint.

Each reusable load-bearing element may have one or more integrally formed features created therein, such as protrusions or recesses. Such protrusions or recesses may be complementary with integral or molded features (e.g., complementary recesses) in adjacent elements. In certain variations, the reusable load-bearing element may have at least one mechanical interlock feature defined therein that may cooperate with a distinct mechanical interlock feature defined in an adjacent element. Thus, a first reusable load-bearing element may comprise a first mechanical interlock feature and the second reusable load-bearing element may comprise a second mechanical interlock feature, where the first mechanical interlock feature is configured to be complementary to the second mechanical interlock feature. Notably, the plurality of reusable load-bearing elements used to create the load-bearing structure may have distinct designs and distinct features from one another (e.g., may have different shapes, some may be solid while others have void regions, and the like).

For purposes of forming large load-bearing structures, each reusable load-bearing element has at least one dimension that is greater than or equal to about 1 meter. In one variation, each reusable load-bearing element forming the load-bearing structure respectively has a first dimension of greater than or equal to about 0.3 meters (about 1 foot), a second dimension of greater than or equal to about 1 meter (about 3 feet), and a third dimension of greater than or equal to about 2 meters (about 6 feet).

Typical construction materials, such as concrete, do not provide the necessary ductility to deform without suffering from brittle fracture, which is necessary for use in modular construction assembly of multiple units. Rather, conventional concrete and metal tend to fracture and permanently deform, respectively. However, while not limiting the reusable load-bearing elements to only such materials, one material for forming reusable load-bearing elements provides the strength advantages of concrete and/or steel, but that lacks the attendant weaknesses in those materials is Engineered Cementitious Composites (ECC). ECC is a fiber-reinforced cement based composite that resembles concrete in many ways, but is desirably non-brittle. ECC material is extremely resilient, and develops a “give” similar to the behavior of wood when overloaded under force. Further, a large body of experimental data has been collected on the durability of ECC, demonstrating service life at least ten times that of normal concrete. Another plausible material for forming the units would be Engineering Geopolymer Composites (EGC) designed similarly as for ECC, but with a geopolymer matrix rather than a Portland cement mortar matrix.

In certain aspects, the present disclosure contemplates forming the reusable load-bearing elements by additive manufacturing with a printable cementitious composition that is also an Engineered Cementitious Composites (ECC). The printable cementitious composition has a fresh state and a hardened state. In the fresh state, the composition is flowable and extrudable in the additive manufacturing process and in the hardened state, the composition exhibits strain hardening. The cementitious composition comprises Portland cement, a calcium aluminate cement, a fine aggregate, water, a high range water reducing agent (HRWRA), and a polymeric fiber. Such a cementitious composition is described in WO 2019/089771 to Soltan et al. entitled “Self-Reinforced Cementitious Composite Compositions for Building-Scale Three Dimensional (3D) Printing,” the relevant portions of which are incorporated herein by reference.

In one aspect, the hardened state of the cementitious composition has a uniaxial tensile strength of greater than or equal to about 2.5 MPa, a tensile strain capacity of greater than or equal to about 1%, and a compressive strength at 100 hours of greater than or equal to about 20 MPa.

In certain variations, a printable cementitious composition for additive manufacturing comprises Portland cement, a calcium aluminate cement, a fine aggregate, water, a high range water reducing agent (HRWRA), and a polymeric fiber.

A Portland cement typically comprises inorganic compounds, such as dicalcium silicate (C₂S or 2CaO.SiO₂), tricalcium silicate (C₃S or 3CaO.SiO₂), tricalcium aluminate (C₃A or 3CaO.Al₂O₃), and tetracalcium aluminoferrite (C₄AF or 4CaO.Al₂O₃.Fe₂O₃), which may be hydrated. Commercially available Portland cement often includes additives, such as gypsum (calcium sulfate) that serves as a set retardant, and pozzolans, like fly ash and ground granulated blast furnace slags (GGBFS), that can react with calcium hydroxide and water to form calcium silicate hydrates or calcium aluminate hydrates. When pozzolans are added to Portland cement, they are considered to be blended cements. ASTM, International Test C 150 called the “Standard Specification for Portland Cement” provides eight types of ordinary Portland cement for different applications, namely: Types I, IA, II, IIA, III, IIIA, IV, and V. In certain non-limiting aspects, the Portland cement used in the cementitious composition is Type I. The Portland cement may be present in the cementitious composition at greater than or equal to about 25 mass/weight % to less than or equal to about 98 mass % of the total mass of cementitious binder components, optionally at greater than or equal to about 30 mass/weight % to less than or equal to about 90 mass % of the total mass of cementitious binder components, optionally at greater than or equal to about 40 mass/weight % to less than or equal to about 90 mass % of the total mass of cementitious binder components, optionally at greater than or equal to about 50 mass/weight % to less than or equal to about 90 mass % of the total mass of cementitious binder components, optionally at greater than or equal to about 60 mass/weight % to less than or equal to about 90 mass % of the total mass of cementitious binder components, and in certain variations, optionally at about 72% by mass of the total mass of the cementitious binder components. In other aspects, the Portland cement may be present in the cementitious composition at greater than or equal to about 15 mass % to less than or equal to about 55 mass % of the total composition, optionally at greater than or equal to about 25 mass % to less than or equal to about 45 mass % of the total mass of the total, overall material composition. In certain variations, the Portland cement is present at greater than or equal to about 32 mass % to less than or equal to about 36% by mass. In one embodiment, Portland cement is present in the composition at about 35 mass % of the total, overall composition.

The cementitious composition also includes a calcium aluminate cement. A calcium aluminate cement typically comprises inorganic compounds, such as calcium aluminate (CA or CaO.Al₂O₃), dicalcium aluminate (C₂A or 2CaO.Al₂O₃), and tricalcium aluminate (C₃A or 3CaO.Al₂O₃). Calcium aluminate cement (CA) manipulates the rate of hardening, for example, increasing the rate of hardening of the cementitious composition. An example of a suitable calcium aluminate cement is REFCON® commercially available from Calucem, which has high early strength, refractoriness, high abrasion resistance, and resistance to sulfuric acid corrosion. The calcium aluminate cement may be present in the cementitious composition at greater than 0 mass/weight % to less than or equal to about 15 mass % of the total mass of cementitious binder components, optionally at greater than or equal to about 3 mass/weight % to less than or equal to about 10 mass % of the total mass of cementitious binder components, and in certain variations, optionally at about 5 mass % of the total mass of cementitious binder components. In other aspects, the calcium aluminate cement may be present in the cementitious composition at greater than or equal to about 0.5 mass % to less than or equal to about 6 mass of the total composition, optionally greater than or equal to about 1 mass % to less than or equal to about 4 mass % of the total composition. In one variation, the calcium aluminate cement is present in the cementitious composition at about 2.4 mass % of the total composition.

The cementitious composition also includes a fine aggregate, such as an inert sand or inert finely crushed stone. Fine aggregates have a particle size distribution having approximately 95% passing on a 9.5 mm sieve (⅜ inch sieve). In certain variations, the fine aggregate is sand. The solid aggregate is distributed within the cementitious matrix to form a composite. In certain variations, the aggregate may be substantially homogeneously distributed within the cementitious composite (e.g., concrete) that is formed. The fine aggregate may comprise sand that has an average particle size of less than or equal to about 2 mm. In one non-limiting variation, the aggregate may be an F-75 silica or quartz sand commercially available from U.S. Silica. The fine aggregate may be present in the cementitious composition at greater than or equal to about 20 mass/weight % to less than or equal to about 65 mass % of the total mass of cementitious binder components, optionally at greater than or equal to about 30 mass/weight % to less than or equal to about 60 mass % of the total mass of cementitious binder components, and in certain variations, optionally at about 45 mass % of the total mass of cementitious binder components. In other aspects, the fine aggregate, such as sand, may be present in the cementitious composition at greater than or equal to about 10 mass % to less than or equal to about 40 mass % of the total composition, optionally greater than or equal to about 10 mass % to less than or equal to about 30 mass % of the total composition.

The cementitious composition also includes a high range water reducing agent (HRWRA), also known as a plasticizer/superplasticizer. Inclusion of the HRWRA can serve to reduce water content needed in the cementitious composition by about 10% to about 30%. The HRWRA can create high fluidity with good flowability properties for the cementitious composition, contributing to making the cementitious composition suitable for additive manufacturing by helping to eliminate the need for any vibration or compaction after deposition. An example of a suitable HRWRA is a low viscosity polycarboxlate based high-range water-reducing admixture commercially available from W.R. Grace as ADVA® 190. The HRWRA may be present in the cementitious composition at greater than or equal to about 0.3 mass/weight % to less than or equal to about 1.5 mass % of the total mass of cementitious binder components, optionally at greater than or equal to about 0.4 mass % to less than or equal to about 1.3 mass % of the total mass of cementitious binder components, optionally in certain variations, at about 0.8 mass % of the total mass of cementitious binder components. In other aspects, the HRWRA may be present in the cementitious composition at greater than or equal to about 0.1 mass % to less than or equal to about 0.8 mass % of the total composition. In one variation, the total cementitious composition has about 0.4 mass % HRWRA.

In other aspects, the cementitious composition comprises at least one type of polymeric fiber distributed within the cementitious matrix to form a composite (in combination with the aggregate solid material). In certain variations, the plurality of polymer fibers may be substantially homogeneously distributed within the cementitious composite (e.g., concrete) that is formed. In certain aspects, the plurality of polymer fibers may be substantially aligned in a predetermined direction as the cementitious composition is deposited via additive manufacturing. The polymer fibers may have a single composition or may include a mixture of different compositions or other combinations of select properties, such as different lengths or diameters. The polymer fibers may include a variety of distinct polymers; however, in certain variations, the fibers may comprise polyvinyl alcohol (PVA) or polyalkylene fibers, such as polyethylene (PE) or polypropylene (PP), including high tenacity polypropylene (HTPP) fibers. In other aspects, the polymer fibers may be natural polymer fibers, such as sisal, jute, curaua fibers, and/or cellulose-based fibers. In certain variations, the polymeric fibers may be oil coated. The oil coating may be greater than or equal to about 1 to less than or equal to about 1.5% by mass, for example, about 1.2% by mass, of the total mass/weight of the fiber and oil coating combined.

An aspect ratio of the polymer fiber can be a factor in generating a cementitious composition having the desired behavior of printability and tensile ductility. While maximizing length of the fiber is advantageous for increasing mechanical strength of the cementitious composite formed, including too long of a fiber in the cementitious composition can impact processability during 3D printing, for example, cause balling or agglomeration that can clog/block the 3D printing system. The polymer fiber may have an aspect ratio (AR) or ratio between a length of the fiber (L) and a diameter (D) of the fiber (AR=L/D) of greater than or equal to about 150. In certain variations, the AR may be greater than or equal to about 150 to less than or equal to about 900. For PVA fibers, an exemplary AR may be about 300, while for polypropylene fibers, an exemplary AR may be about 800.

In certain variations, a polymer fiber used in the cementitious composition has a length of greater than or equal to about 4 mm to less than or equal to about 20 mm, optionally greater than or equal to about 6 mm to less than or equal to about 15 mm, optionally greater than or equal to about 8 mm to less than or equal to about 12 mm, and in certain variations, optionally greater than or equal to about 8 mm to less than or equal to about 10 mm. In certain variations, a polymer fiber used in the cementitious composition has a diameter of greater than or equal to about 10 micrometers (μm) to less than or equal to about 200 μm. In one variation, the polymeric fiber is a PVA fiber that may have a length of about 12 mm and a diameter of about 40 micrometers. In another variation, the polymeric fiber is a PP fiber that may have a length of about 12 mm and a diameter of about 12 micrometers. The polymer fiber may be present in the cementitious composition at greater than or equal to about 1 vol. % to less than or equal to about 4.5 vol. % of the total volume of the cementitious composition, optionally at greater than or equal to about 1.8 vol. % to less than or equal to about 4 vol. %, and in certain variations, optionally at about 2 vol. %. In certain compositions, 2 vol. % is about 2.9 mass/weight %.

Water is also included in the cementitious composition. A mass ratio of water to cementitious binder components (e.g., Portland cement, calcium aluminate, and any other pozzolanic materials, like fly ash) may be greater than or equal to about 0.2 to less than or equal to about 0.55. In one variation, a mass ratio of water to cementitious binder components is about 0.43. Water temperature can be used to intentionally manipulate the fresh state properties of a particular cementitious material composition. Water temperature affects fresh state rheological properties due to the accelerated activation of pozzolanic reactions of the cementitious materials. Water may be present in the cementitious composition at greater than or equal to about 10 mass % to less than or equal to about 35 mass % of the total cementitious composition. In one variation, the water may be present at about 20 to about 21% by mass of the total composition (e.g., about 20.7%).

In certain variations, the cementitious composition further comprises one or more components selected from the group consisting of: fly ash, microsilica, silica flour, attapulgite nanoclay, a cellulose-based additive, and combinations thereof.

Fly ash can be added to the cementitious composition and serves as a pozzolan/cementitious material. Fly ash is an industrial byproduct, for example, collected from effluent of a coal burning boiler unit. It can be used as a substitute for a portion of the Portland cement to reduce energy consumption required to form the overall product and increase the environmental friendliness of the cementitious composition, while contributing to the cementitious properties of the matrix/binder system of the concrete composite. In one variation, the fly ash may be a Class F fly ash as designated by ASTM C618, which is formed from combustion of anthracite and/or bituminous coals. ASTM C618 requires that Class F fly ash contain at least 70% pozzolanic compounds (silica oxide, alumina oxide, and iron oxide). The fly ash may be present in the cementitious composition at 0 mass/weight % to less than or equal to about 45 mass % of the total mass of cementitious binder components, optionally at 0 mass % to less than or equal to about 35 mass % of the total mass of cementitious binder components, an in certain aspects, optionally at about 23 mass % of the total mass of cementitious binder components. In other aspects, the fly ash may be present in the cementitious composition at 0 mass % to less than or equal to about 25 mass % of the total cementitious composition. In one variation, the fly ash is present at about 11 mass % of the total composition.

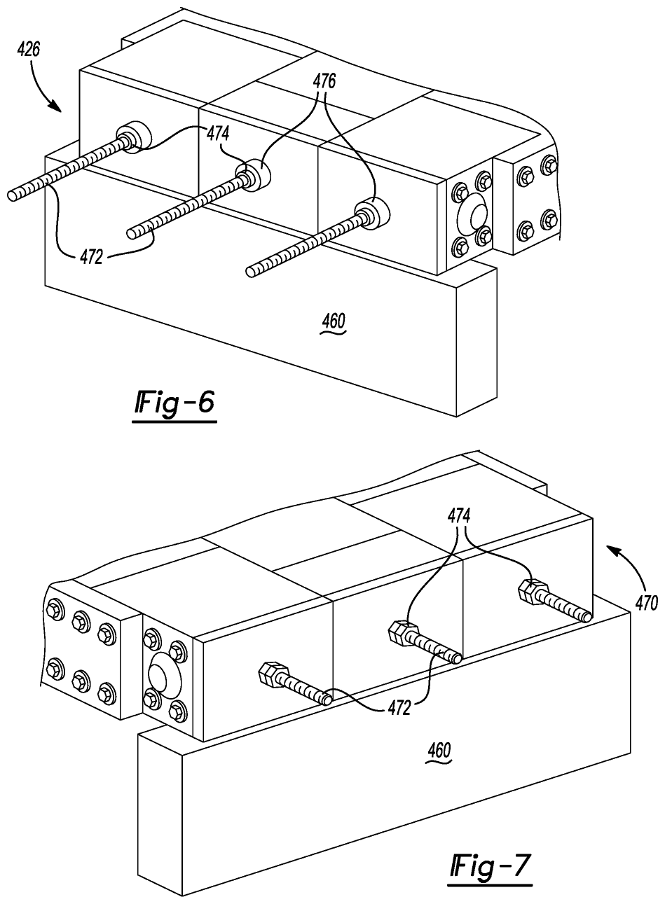

Microsilica (MS) can be substituted for silica sand by weight. Microsilica generally has an average particle size of greater than or equal to about 50 nm to less than or equal to about 200 μm. In one variation, an average particle size of the microsilica is greater than or equal to about 50 nm to less than or equal to about 200 nm, for example, a mean particle size may be about 150 nm (less than 0.1% of primary particles have a particle size of greater than 450 nm). Microsilica increases a rate of hardening (see for example, FIG. 6); however, a significant increase in water content is required to produce proper dispersion of fiber in the cementitious composition, and effects of the increase in water dominate at the higher water contents. Though the higher water contents produce acceptable early flowability, they also produce longer time to hardening. A suitable microsilica is Elkem Microsilica® 955, which is commercially available from Elkem. When present, the microsilica may be present in the cementitious composition at 0 mass % to less than or equal to about 30 mass % of the total mass of cementitious binder components, optionally at 0 mass % to less than or equal to about 20 mass % of the total mass of cementitious binder components, an in certain aspects, optionally at about 10 mass % of the total mass of cementitious binder components. In other aspects, the microsilica may be present in the cementitious composition at 0 mass % to less than or equal to about 15 mass % of the total cementitious composition. In one variation, the microsilica may be present at greater than or equal to about 4 mass % to less than or equal to about 5 mass % of the total composition, for example, at about 4.8 mass %.

Ground silica, also called silica flour, may be added to the cementitious composition and generally has a particle size of greater than or equal to about 40 μm to less than or equal to about 300 μm. Introducing ground silica (GS), in addition to microsilica (MS) allows both the early flowability and a rapid rate of hardening. This is likely due to a more even particle size distribution caused by the substitution of MS and GS for silica sand—the GS has an average particle size between those values of F-75 silica sand and MS. For example, microsilica has an average particle size of about 150 nm, ground silica has an average particle size of greater than or equal to about 40 to less than or equal to about 70 micrometers, and silica sand has an average particle size of greater than or equal to about 200 to less than or equal to about 300 micrometers. A suitable ground silica/silica flour is U.S. Silica brand Sil-Co-Sil™ 75 (crystalline quartz). The ground silica may be present in the cementitious composition at 0 mass % to less than or equal to about 20 mass % of the total mass of cementitious binder components optionally at 0 mass % to less than or equal to about 10 mass % of the total mass of cementitious binder components, an in certain aspects, optionally at about 5 mass % of the total mass of cementitious binder components. In other aspects, the ground silica may be present in the cementitious composition at 0 mass % to less than or equal to about 10 mass % of the total cementitious composition. In one variation, the ground silica may be present at greater than or equal to about 2 mass % to less than or equal to about 3 mass % of the total composition, for example, at about 2.4 mass %.

In various aspects, the total cumulative amount of aggregate in the cementitious composition, including any fine aggregate like sand, microsilica, and ground silica may be greater than or equal to about 15 mass % to less than or equal to about 60 mass % of the total composition.

In yet other aspects, the cementitious composition includes a cellulose-based additive, such as hydroxypropylmethyl cellulose (HPMC). Generally, the HPMC manipulates viscosity of the inventive cementitious composition in its the fresh state, for example, it can be used as thickening agent to increase viscosity, prevent segregation during pumping, and promote thixotropy. The cellulose-based additive may be present in the cementitious composition at 0 mass % to less than or equal to about 1.5 mass % of the total mass of cementitious binder components optionally at 0 mass % to less than or equal to about 0.8 mass % of the total mass of cementitious binder components, and in certain aspects, optionally at about 0.4 mass % of the total mass of cementitious binder components. In other aspects, the cellulose-based additive may be present in the cementitious composition at greater than or equal to about 0 mass % to less than or equal to about 0.6 mass % of the total cementitious composition. In one variation, the cellulose-based additive may be present at about 0.19 mass % of the total composition mass.

In certain aspects, the cementitious composition includes an attapulgite nanoclay (ANC). The attapulgite nanoclay promotes thixotropy of the cementitious composition in its fresh state during additive manufacturing. The effect on workability evolution of ANC dosages shows a thickening effect, where the flowability (flowability factor, Ff) is decreased and time to hardening is prolonged when mixed into large batch sizes. Thus, rate of hardening is slightly increased when the attapulgite nanoclay is included. An effect on the mitigation of workability loss is also observed at the 0.5% cementitious material basis (C.M.) and 0.8% C.M. dosages of ANC, as discussed further below. One suitable exfoliated attapulgite nanoclay is an Active Minerals International product called ACTIGEL™ 208, which is a highly purified hydrous magnesium aluminum-silicate (attapulgite) made from a proprietary process that creates pure, uniformly sized, rod-shaped mineral particles. When present, the ANC may be present in the cementitious composition at 0 mass % to less than or equal to about 3 mass % of the total mass of cementitious binder components optionally at 0 mass % to less than or equal to about 2 mass % of the total mass of cementitious binder components, an in certain aspects, optionally at about 0.5 mass % of the total mass of cementitious binder components. In other aspects, the ANC may be present in the cementitious composition at 0 mass % to less than or equal to about 0.9 mass % of the total cementitious composition. In one variation, the ANC is present at about 0.25 mass % of the total composition mass.

In certain variations of the bendable and printable engineered cementitious composition, Portland cement is present at greater than or equal to about 25 mass % to less than or equal to about 40 mass % of the total mass of the composition, calcium aluminate cement is present at greater than or equal to about 1 mass % to less than or equal to about 4 mass % of the total mass of the composition, the fine aggregate is present at greater than or equal to about 18 mass % to less than or equal to about 35 mass % of the total mass of the composition, water is present at greater than or equal to about 18 mass % to less than or equal to about 30 mass % of the total mass of the composition, the high range water reducing agent (HRWRA) is present at greater than or equal to about 0.2 mass % to less than or equal to about 0.6 mass % of the total mass of the composition, and the polymeric fiber is present at greater than or equal to about 0.7 mass % to less than or equal to about 2.1 mass % of the total mass of the composition. Other components may also be present in the composition.

In certain other variations, the bendable and printable engineered cementitious composition comprises Portland cement at greater than or equal to about 30 to less than or equal to about 40 mass % of the cementitious composition, calcium aluminate cement is present at greater than or equal to about 1 to less than or equal to about 4 mass % of the total cementitious composition, the fine aggregate is present at greater than or equal to about 18 to less than or equal to about 40 mass % of the cementitious composition, water is present at greater than or equal to about 18 to less than or equal to about 30 mass % of the cementitious composition, the high range water reducing agent (HRWRA) is present at greater than or equal to about 0.2 to less than or equal to about 0.6 mass % of the cementitious composition, and the polymeric fiber is present at greater than or equal to about 0.7 to less than or equal to about 2.1 mass % of the total composition by mass. All ranges are given in percentage by weight of the overall weight of the total composition in the unmixed state.

In yet other variations, the bendable and printable engineered cementitious composition comprises Portland cement present at greater than or equal to about 25 mass % to less than or equal to about 40 mass % of the total mass of the composition, calcium aluminate cement present at greater than or equal to about 1 mass % to less than or equal to about 4 mass % of the total mass of the composition, the fine aggregate present at greater than or equal to about 18 mass % to less than or equal to about 38 mass % of the total mass of the composition, water present at greater than or equal to about 18 mass % to less than or equal to about 35 mass % of the total mass of the composition, the high range water reducing agent (HRWRA) present at greater than or equal to about 0.2 mass % to less than or equal to about 0.6 mass % of the total mass of the composition, the polymeric fiber present at greater than or equal to about 0.7 mass % to less than or equal to about 2.2 mass % of the total mass of the composition, the fly ash present at greater than or equal to about 5 mass % to less than or equal to about 15 mass % of the total mass of the composition, the silica flour present at greater than or equal to about 0.1 mass % to less than or equal to about 5.0 mass % of the total mass of the composition, the microsilica present at greater than or equal to about 2.0 mass % to less than or equal to about 8.0 mass % of the total mass of the composition, the attapulgite nanoclay present at greater than or equal to about 0.1 mass % to less than or equal to about 5.0 mass % of the total mass of the composition, the hydroxypropylmethyl cellulose (HPMC) present at greater than or equal to about 0.05 mass % to less than or equal to about 0.5 mass % of the total mass of the composition.

In various aspects, each reusable load-bearing element formed from a printable cementitious composition may have a hardened state with a compressive strength at 28 days of greater than or equal to about 25 MPa. Further, each reusable load-bearing element may have a uniaxial tensile strength of greater than or equal to about 2.5 MPa, a tensile strain capacity of greater than or equal to about 1%.

In one variation, a bendable concrete or engineered cementitious composite (ECC) composition comprises ASTM Type I Portland cement, Class F fly ash, finely ground quartz sand, polyvinyl alcohol (PVA) fibers, and tap water. The quartz sand has an average diameter of 75 μm and a density of 2.63 g/cm³. The PVA fibers have a length of 8 mm, a diameter of 39 μm, and 1,300 kg/m³ in density. In one variation, the PVA fibers have a tensile strength of about 1.6 GPa, a Young's modulus of 43 GPa, and an ultimate elongation of about 6% to about 8%, respectively. In the mixture, the water-to-binder ratio may be 0.25; the sand-to-binder ratio may be 0.36; and the PVA fiber volume percentage is 2% by the volume of the cementitious composition. The binder matrix comprises 30% cement and 70% fly ash, by mass. A high range water reducer (HRWRA) is used at a dosage of 0.1% by volume of the binder matrix to make the mixture self-consolidating.

The bendable and printable engineered cementitious composition is a version of Engineered Cementitious Composite (ECC) featured with high tensile ductility. Typically, the tensile strain corresponding to the peak tensile stress is higher than 4%, which is more than 400 times that of conventional concrete. Once cracked, conventional concrete fails to resist tensile force, while ECC maintains resistance to tensile force. Compared with fiber-reinforced concrete, ECC exhibits strain-hardening behavior, which means that the tensile stress continues to increase with the tensile strain after initial microcracking. The unique tension resistance of the engineered cementitious composite (ECC) compositions makes it an attractive structural material for resistance to seismic loading, impact loading, and bolting or anchoring force.

In addition to the unique tension resistance, ECC has unique crack patterns and durability. Due to the bridging effect of chopped fibers dispersed in ECC matrix, ECC has controlled tight crack widths (less than or equal to approximately 60 μm). The controlled crack width ensures that cracked ECC behaves similar to uncracked ECC, in terms of the transport properties. More interestingly, the tight crack can be self-healed in air with presence of moisture. The healed ECC demonstrates comparable stiffness and permeability with those of intact ECC specimens. The use of PVA fibers in ECC also improved the spalling resistance of ECC at high temperature or in fire hazards. Further, it is contemplated that the ECC compositions may also have multifunctionality by incorporating functional materials. For instance, carbon black can be used to increase the electrical conductivity of ECC and achieve a self-sensing function; titanium dioxide nanoparticles may be added to ECC to achieve self-cleaning and air-purifying functions.

Each load-bearing element may be formed by depositing the printable cementitious composition in a fresh state on a substrate. For example, the printable cementitious composition may be passed through an aperture to deposit the cementitious composition onto a target. In the fresh state, the cementitious composition is flowable and extrudable and after the depositing, the cementitious composition forms a hardened state exhibiting a uniaxial tensile strength of greater than or equal to about 2.5 MPa, a tensile strain capacity of greater than or equal to about 1%, and a compressive strength at 100 hours of greater than or equal to about 20 MPa. Additionally or alternatively, each load-bearing element may be formed by filling a cavity of a preform or mold with an engineered cementitious compositions, whether by printing or by traditional methods of filling molds.

In other aspects, the cementitious composition is an Engineered Geopolymer Composite (EGC), such as those described in “Ohno, et al., “An Integrated Design Method of Engineered Geopolymer Composite,” Cement and Concrete Composites 88, pp. 73-85 (2018), the relevant portions of which are incorporated by reference herein. As noted above, EGC materials are similar to ECC materials described above, including printable ECC materials, but lack a Portland cement matrix. Thus, generally EGC compositions are strain-hardening fiber-reinforced geopolymer composites with high tensile ductility and multiple micro-cracking characteristics.

Generally, one suitable EGC composition comprises fly ash, such as a Type F fly ash described above, a fine aggregate, as described silica sand described above, sodium silicate (Na₂SiO₃), sodium hydroxide (NaOH), a polymeric fiber such as those described above, and water.

One suitable EGC engineered cementitious composition comprises fine aggregate present at greater than or equal to about 17 to less than or equal to about 22 mass % of the cementitious composition, fly ash present at greater than or equal to about 50 to less than or equal to about 60 mass % of the cementitious composition, water is present at greater than or equal to about 7 to less than or equal to about 12 mass % of the cementitious composition, the polymeric fiber is present at greater than or equal to about 0.7 to less than or equal to about 1.5 mass % of the cementitious composition, sodium silicate (NaSiO₃) present at greater than or equal to about 10 to less than or equal to about 15 mass % of the cementitious composition, and sodium hydroxide (NaOH) present at greater than or equal to about 2.5 to less than or equal to about 3.5 mass % of the cementitious composition.

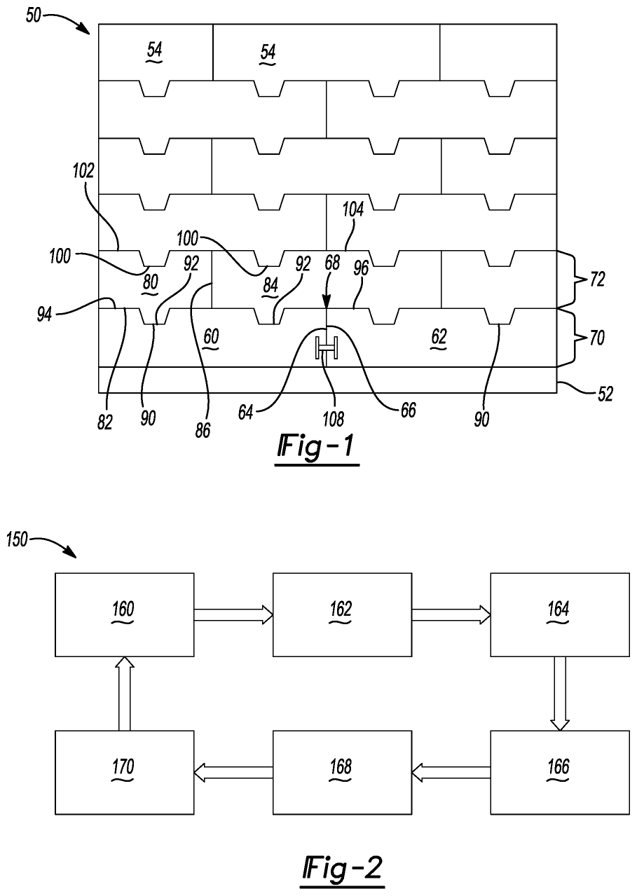

As shown in the non-limiting simplified design in FIG. 1, a load-bearing structure 50 in the form of a wall for a building has been formed on a substrate 52 (which may be ground) by assembling a plurality of reusable load-bearing elements 54 together. The load-bearing structure 50 may be formed by placing a first reusable load-bearing element 60 adjacent to a second reusable load-bearing element 62, so that the first reusable load-bearing element 60 is fixed with respect to the second reusable load-bearing element 62. The first reusable load-bearing element 60 and the second reusable load-bearing element 62 each have a complementary lateral surface 64, 66 that can be positioned adjacent to and in contact with one another and thus define an interface 68 therebetween. The interface 68 may thus form a tight joint with minimal clearance therebetween and in certain aspects, may be water tight or weatherproof. In certain variations, a distinct material, such as an adhesive, mortar, membrane, insulating material, or the like may be disposed between the first reusable load-bearing element 60 and the second reusable load-bearing element 62; however, in certain preferred aspects, there is no additional material disposed therebetween. In conventional construction techniques, wet joints are formed with mortar, adhesives, or chemical joints. Thus, in certain aspects, no adhesive or mortar are used to fix the reusable load-bearing elements 54 to one another in certain embodiments. The lack of any adhesive or mortar used in forming the load-bearing structure 50 provides an enhanced ability to reuse the load-bearing elements 54 after disassembly. The first reusable load-bearing element 60 and the second reusable load-bearing element 62 thus define a first row 70 of the in the load-bearing structure 50.

The method further includes placing a third reusable load-bearing element 80 over an upper surface 82 of the first reusable load-bearing element 60. A fourth reusable load-bearing element 84 is disposed over a portion of the first reusable load-bearing element 60 on the upper surface 82 and adjacent to a lateral surface 86 of the third reusable load-bearing element 80. As can be seen, the third reusable load-bearing element 80 and the fourth reusable load-bearing element 84 are different dimensions from one another. The third reusable load-bearing element 80 and the fourth reusable load-bearing element 84 define a second row 72 of the load-bearing structure 50. Moreover, the first reusable load-bearing element 60 and the second reusable load-bearing element 62 have distinct shapes from the third reusable load-bearing element 80, and the fourth reusable load-bearing element 84, where the first reusable load-bearing element 60 and the second reusable load-bearing element 62 have a planar or flat bottom corresponding to the planar surface of the substrate 52.

Notably, each of the first reusable load-bearing element 60, the second reusable load-bearing element 62, the third reusable load-bearing element 80, and the fourth reusable load-bearing element 84 have a preformed integrally formed interlock feature defined therein. More specifically, the first reusable load-bearing element 60 and the second reusable load-bearing element 62 each have a recessed region 90 (e.g., formed on the upper surface 82). Each of the third reusable load-bearing element 80 and the fourth reusable load-bearing element 84 have a preformed integrally formed feature in the form of at least one protrusion 92 on a lower surface 94 of third reusable load-bearing element 80 and a lower surface 96 of the fourth reusable load-bearing element 84. Notably, the protrusions 92 each have a shape and size that is complementary to the recessed regions 90. This is one non-limiting example of a way that each reusable load-bearing element 54 can be fixed to adjacent reusable load-bearing elements.

As shown, the third reusable load-bearing element 80 and the fourth reusable load-bearing element 84 have not only protrusions 92 formed in lower surfaces 94 and 96, respectively, but also recessed regions 100 formed in the upper surfaces 102 and 104 of the third reusable load-bearing element 80 and the fourth reusable load-bearing element 84, respectively. As can be seen in FIG. 1, a plurality of reusable load-bearing elements 54 can thus be placed and assembled together to define the load-bearing structure 50. As will be appreciated, FIG. 1 is a simplified view of the concept of modular construction, but can be used to form complex three-dimensionally shaped structures with a variety of distinct kinds of reusable load-bearing elements.

In certain aspects, the forming of the load-bearing structure may further comprise coupling the first reusable load-bearing element to the second reusable load-bearing element after the placing. In certain aspects, this may simply include disposing a reusable load-bearing element having one or more integrally formed features such that it nests or mates with an adjacent reusable load-bearing element. In other embodiments, the coupling may comprise joining one or more regions of the reusable load-bearing elements via a mechanical interlock. For example, a first reusable load-bearing element comprises a first mechanical interlock feature and the second reusable load-bearing element comprises a second mechanical interlock feature, wherein the first mechanical interlock feature is configured to be complementary to the second mechanical interlock feature. In certain other variations, the first reusable load-bearing element and the second reusable load-bearing element may also be joined or coupled together, for example, by one or more fasteners 108, which may include a bolt with nuts that couple the complementary lateral surface 64, 66 of the first reusable load-bearing element 60 and the second reusable load-bearing element 62 at interface 68. Notably, while not shown, such fasteners 108 may be selectively placed in certain regions of the load-bearing structure 50 rather than at every lateral interface. Thus, in certain aspects, the coupling comprises mechanically fastening the first reusable load-bearing element to the second reusable load-bearing element.

Where the reusable load-bearing elements are formed of a material like ECC, a variety of joining or coupling methods are contemplated. This includes, for example, traditional wood joining method using tongue and groove, which may be supplemented by use of adhesives. An alternative form of wood jointing using nuts and bolts (for example, steel nuts and bolts) may be more suitable for automated assembly and disassembly, instead of using glue. In general, the steel bolt can be put in tension, although concentrated compressive stresses will still be applied to the reusable load-bearing element. The non-brittle nature of ECC materials helps to avoid local failure at the joint both during bolt tensioning and during structural loading, which is not possible with conventional concrete structures and bricks that exhibit brittle fracture when excessive loading is applied. ECC materials provide a balanced combination of compressive strength and tensile ductility that desirably provide for the damage-tolerant performance of the ECC in the anchorage zone.

Notably, in certain variations, the first reusable load-bearing element and the second reusable load-bearing element each comprise a cementitious material substantially free of any metal reinforcement components, such as metal rebar. In certain other variations, the load-bearing structure may be substantially free of any metal reinforcement components, such as metal rebar. While in certain variations, the load-bearing structure may consist essentially of the reusable load-bearing elements, in other variations, other materials including reinforcements, doors, windows, and other components may be integrated into the load-bearing structure during the fabrication process. However, for larger load-bearing structures, such as bridges, roads, and skyscrapers by way of non-limiting example, metal reinforcements may be included in the load-bearing structure. Thus, in certain aspects, post-tensioning of the assembled load-bearing structure is contemplated. The post-tensioning, similar to the reusable load-bearing elements, can be easily disassembled at end of life of the structure.

While the placing of reusable load-bearing elements 54 may be done manually by laborers, in certain aspects, the placing of each reusable load-bearing element 54 of the plurality that are used to form the load-bearing structure 50 may be accomplished by an automated and/or computer guided process. In certain aspects, an automated process may include robots that place individual reusable load-bearing elements 54.

In certain other aspects, the present disclosure contemplates further dissembling the load-bearing structure by removing each respective reusable load-bearing element. The load-bearing structure can be considered to be an initial load-bearing structure and a second load-bearing structure can be formed from at least one of the first reusable load-bearing element and the second reusable load-bearing element. Notably, any reusable load-bearing elements that sustained excessive wear or degradation can be selectively removed prior to incorporation into the new upcycled second load-bearing structure. Thus, the first reusable load-bearing element and the second reusable load-bearing element are a portion of a plurality of reusable load-bearing elements that are used to form the load-bearing structure.

In certain other aspects, the methods of the present disclosure further comprise forming the reusable load-bearing elements by additive manufacturing with a printable cementitious composition, as described above. Such reusable load-bearing elements can be formed at a construction site or alternatively pre-fabricated at an offsite facility.

In various aspects, the present teachings provide a new civil infrastructure construction scheme capable of meeting various objectives, including reducing climate change, addressing labor shortage issues, and enhancing construction productivity. In certain variations, high quality damage-tolerant reusable load-bearing elements can be designed and 3D printed, with few limitations on the size and complexity of the load-bearing structures that can be formed from such reusable load-bearing elements when they are assembled together. Moreover, such reusable load-bearing elements can be easily disassembled back into individual units and therefore can be reconfigured and used in other projects.

In certain aspects, the reusable load-bearing elements can be manufactured in highly automated factories, allowing for a high-tech knowledge-intensive operation that replaces labor-intensive construction jobs. In a modern factory environment, additive manufacturing technology (3D printing) can be employed to result in high precision load-bearing elements with little or no waste stream. 3D printing also allows intricate details and integrally formed features to be defined within each respective load-bearing element. On-site assembly of the manufactured load-bearing elements can also utilize modern robotics for laser-guided positioning and rapid jointing of the respective elements. At the end-of-life for the load-bearing structure, these same technologies can be applied for efficient de-construction, allowing for rapid disassembly and reconfiguration into a new structure.

A lifecycle 150 for a load-bearing element according to certain aspects of the present disclosure is depicted in FIG. 2. More specifically, at 160, reusable damage-tolerant load-bearing elements can first be designed. Next, at 162, the reusable damage-tolerant load-bearing elements can be 3D printed via additive manufacturing in factories from a printable cementitious ECC material. In certain aspects, the load-bearing elements can be tagged and inventoried in distributed warehouses, selected (based on information from digitized architectural or structural designs) and transported to construction sites and assembled into structures using computer vision aided robots.

At 164, building information modeling (BIM) and digital design of a specific load-bearing structure (e.g., infrastructure) comprising the reusable damage-tolerant load-bearing elements formed at 160 is conducted. At 166 at the construction site, robotic assembly (which can be supplemented by manual assembly) can be used to form the load-bearing structure, such as a building. At 168 when the load-bearing structure (e.g., a building) reaches a point of end-of-life, the structure comprising the reusable damage-tolerant load-bearing elements can be disassembled robotically (which can be supplemented by manual disassembly) and refurbished. The individual load-bearing elements will move onto another construction site and can be reconfigured into a different structure (e.g., a bridge) or returned to inventory for future reuse.

Thus, at 170, partial or full robotic assembly of the reusable load-bearing elements can be used to form a second downstream load-bearing structure. Prior to reassembly, if embedded sensors detect deterioration, the damaged load-bearing element will be returned to the factory, where it can be refurbished before being inventoried. The emphasis can be on construction automation and digitization, and complete element/material reuse and carbon sequestration, through creating rapidly joinable modular elements.

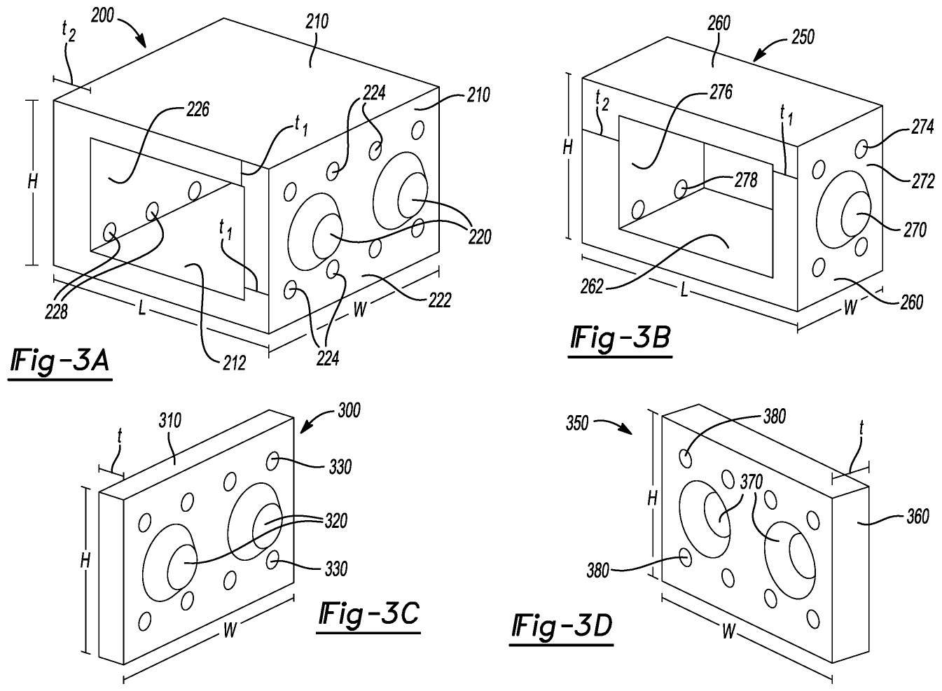

FIGS. 3A-3D show a representative system of reusable damage-tolerant load-bearing elements for use in a modular building system in accordance with certain aspects of the present disclosure. In general, the reusable damage-tolerant load-bearing elements (referred to herein as “elements”) fulfil one or more of the following criteria: (1) the elements are connected with dry joints that can be disconnected without damaging the elements; (2) the joints are not the weakest positions that limit the mechanical performance of the elements; (3) the elements have suitably high mechanical load resistance; (4) the assembling and disassembling operations can be performed by robotic systems; and (5) the elements can be prefabricated offsite with high quality. In addition to these requirements, the elements describe herein are also suitable for manual operation by a single person. With these considerations, the elements are designed to be jointed via dry joints of mechanical fasteners in the form of shear keys and steel bolts.

As shown in FIG. 3A, a first reusable damage-tolerant load-bearing element 200 defines four walls 210 with a hollow central opening 212 (in that the rectangular prism having six sides does not have walls on two sides and there is no material in the central area). In alternative variations not shown, the rectangular prism may have material in the central region. The first element 200 includes at least two interlock features in the form of protrusions 220 defined on a first wall 222. As shown, the protrusions 220 define a truncated tapered cylinder shape that are capable of seating within a recess having a complementary shape. However, other shapes that permit seating or nesting with a complementary recess during assembly and ready removal during disassembly are also contemplated. The first wall 222 also includes a plurality of first apertures 224. A second wall 226 also defines a plurality of second apertures 228 aligned with and positioned laterally with the plurality of first apertures 224. The first and second plurality of apertures 224, 228 may be part of a shear key and hole system, where the shear key is a structural feature that is used to provide lateral restraint and reduce sliding of elements, like walls. In this manner, the first and second plurality of apertures 224, 228 are configured to receive at least a portion of a mechanical element, such as a fastener (not shown) like a bolt. Further, as will be described further below, the first and second plurality of apertures 224, 228 are designed to align with other apertures in the system, so that mechanical fasteners can pass therethrough. In certain variations, while FIG. 3A does not show other walls 210 having apertures, those may be included in other walls, depending on the direction and extent of reinforcement required.

In one variation, the first element 200 may have a height “H” of about 220 mm, a width “W” of about 325 mm, and a length “L” of about 300 mm. A first thickness “t₁” of select walls 210 may be uniform in certain variations, for example, about 30 mm. However, as shown, a second thickness “t₂” of second wall 226 is larger than the first thickness “t₁,” for example, it may be 50 mm. The first element 200 may be considered to be a “full” sized block in a modular construction system.

FIG. 3B shows a second reusable damage-tolerant load-bearing element 250 that may be considered to be a “half” element as compared to the first element 200. The second element 250 includes four walls 260 with a hollow central opening 262 that also defines a rectangular prism shape. The second element 250 includes one interlock feature in the form of a protrusion 270 defined on a first wall 272. As shown, the protrusion 270 defines a truncated tapered cylinder shape that is capable of seating within a recess having a complementary shape. However, other shapes that permit seating or nesting with a complementary recess during assembly and ready removal during disassembly are also contemplated. Notably, the protrusion 270 on the first wall 272 of the second element 250 has the same shape as the protrusions 220 defined on the first wall 222 of first element 200 in FIG. 3A. The first wall 272 also includes a plurality of first apertures 274. A second wall 276 also defines a plurality of second apertures 278 aligned with and positioned laterally with the plurality of first apertures 274. The first and second plurality of apertures 274, 278 may be part of a shear key and hole system, as described above, so that the first and second plurality of apertures 274, 278 are aligned with apertures on other elements in the modular building system and are configured to receive at least a portion of a mechanical element, such as a fastener (not shown) like a bolt.

The second element 250 may be considered to be a “half” sized block. In one variation, the second element 250 may have a height “H” of about 220 mm, a width “W” of about 162.5 mm, and a length “L” of about 300 mm. A first thickness “t₁” of select walls 260 may be uniform in certain variations, for example, about 30 mm. However, as shown, a second thickness “t₂” of second wall 276 is larger than the first thickness “t₁,” for example, it may be 50 mm.

FIG. 3C shows a reusable damage-tolerant load-bearing male plate component 300. The male plate component 300 is a solid structure defining one wall 310. The male plate component 300 includes two interlock features in the form of a protrusions 320 defined on the wall 310. As shown, the protrusions 320 define a truncated tapered cylinder shape that is capable of seating within a recess having a complementary shape. However, other shapes that permit seating or nesting with a complementary recess during assembly and ready removal during disassembly are also contemplated. Notably, the protrusions 320 on male plate component 300 are placed in general in the same positions and have the same shape as the protrusions 220 defined on the first wall 222 of first element 200 in FIG. 3A and the protrusion 270 on the first wall 272 of the second element 250 in FIG. 3B. The first wall 310 also includes a plurality of apertures 330. Again, the apertures 330 may be part of a shear key and hole system, as described above, so that the apertures 330 may align with other apertures on other elements in the modular building system and thus are configured to receive at least a portion of a mechanical element, such as a fastener (not shown) like a bolt.

The male plate component 300 may have a height “H” of about 220 mm, a width “W” of about 330 mm or alternatively 162.5 mm, and a thickness “t” of about 30 mm or alternatively 50 mm.

FIG. 3D shows a reusable damage-tolerant load-bearing female plate component 350. The female plate component 350 is a solid structure defining one wall 360. The female plate component 350 includes two interlock features in the form of a recesses 370 defined on the wall 360. As shown, the protrusions 370 define an inverted truncated tapered cylinder shape that is capable of receiving a protrusion having a complementary shape (like protrusions 220 defined on the first wall 222 of first element 200 in FIG. 3A and the protrusion 270 on the first wall 272 of the second element 250 in FIG. 3B). However, other shapes that permit seating or nesting of a complementary protrusion are also contemplated. Notably, the recesses 370 on female plate component 350 are in general disposed in the same positions and have the same shape as the protrusions 220 defined on the first wall 222 of first element 200 in FIG. 3A and the protrusion 270 on the first wall 272 of the second element 250 in FIG. 3B. The wall 360 also includes a plurality of apertures 380. Again, the apertures 380 may be part of a shear key and hole system, as described above, so that the apertures 380 may align with other apertures on other elements in the modular building system and thus are configured to receive at least a portion of a mechanical element, such as a fastener (not shown) like a bolt.

The female plate component 350 may have a height “H” of about 220 mm, a width “W” of about 330 mm or alternatively 162.5 mm, and a thickness “t” of about 50 mm or alternatively 30 mm.

In each of the first element 200, second element 250, male component 300 and female component 350, the placement and number of the interlock features (protrusions and recesses) may differ from those shown. Further, recesses may be protrusions and vice versa. Also, while not shown, certain walls may further contain additional interlock features, e.g., protrusions and recesses.

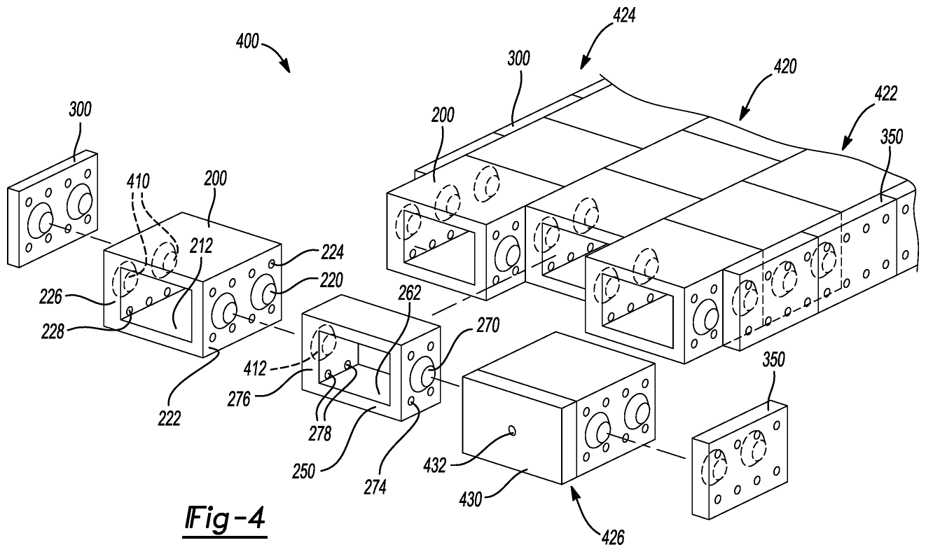

FIG. 4 shows a partially assembled modular building system 400 used to form a load-bearing structure. The modular building system 400 uses a plurality of the first elements 200, the second elements 250, the male components 300 and the female components 350. It should be noted that not each of these types of elements is necessary to form a load-bearing structure, but merely illustrative. As can be seen in FIG. 4, in one example, the first element 200 defines protrusions 220 and the plurality of first apertures 224 on the first wall 222. As further shown in FIG. 4, a first plurality of recesses 410 are defined on the second wall 226, along with the second plurality of apertures 228. Likewise, the second element 250 includes protrusions 270 and the plurality of first apertures 274 on the first wall 272. At least one recess 412 is defined on the second wall 276. The second wall 276 also includes the second plurality of apertures 278. In this manner, the protrusions 220 on the first element 200 are complementary in shape with the recess 412 in the second element 250. In this manner, the first wall 222 of the first element 250 and the second wall 276 of the second element are adjacent to one another, so that the at least one first interlock feature (protrusion 220) seats against the second interlock feature (recess 412). While not shown one or more fasteners may be disposed in the first plurality of aperture 224 and the second plurality of apertures 278 to secure the first element 200 to the second element 250 together without any adhesive or mortar. In this manner, each of the first elements 200, second elements 250, male components 300 and female components 350 can be assembled with one another. The fastener may also pass through other apertures and walls within the system and may be secured at terminal ends or intermediate points within the modular building system 400. As shown, after assembling the first elements 200 and second elements 250 together in a central region 420, the female components 350 are assembled on a first lateral edge 422 that forms an external side of the load-bearing structure being formed. The male components 300 forms a second lateral edge 424 that forms an opposite external side of the load-bearing structure being formed. A plurality of end plates 430 may be used to cap the openings 212 or 262 of first elements 200 or second elements 250 on a first terminal end 426. The end plates 430 may have one or more openings 432 that can receive tensioners.

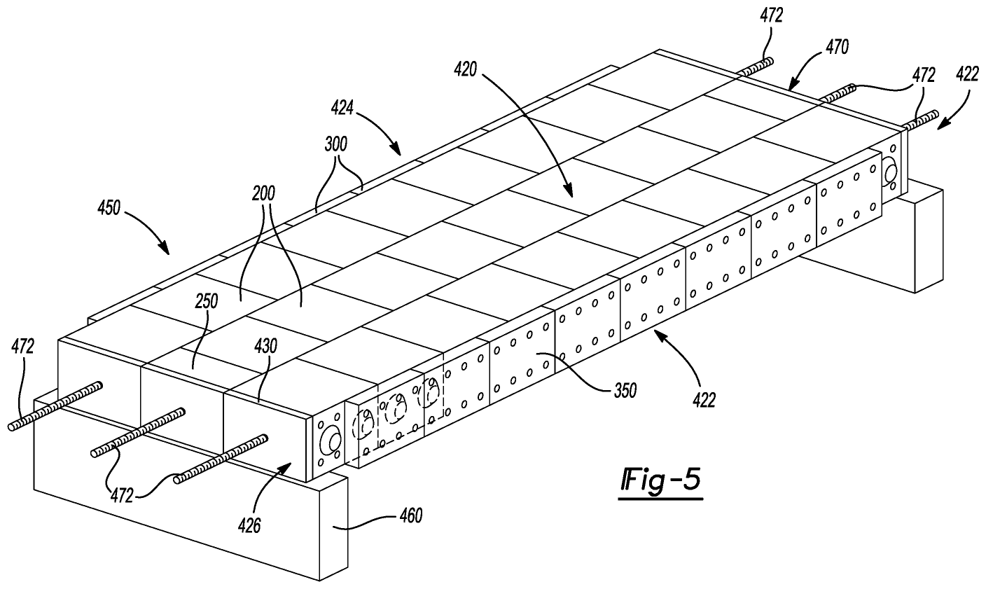

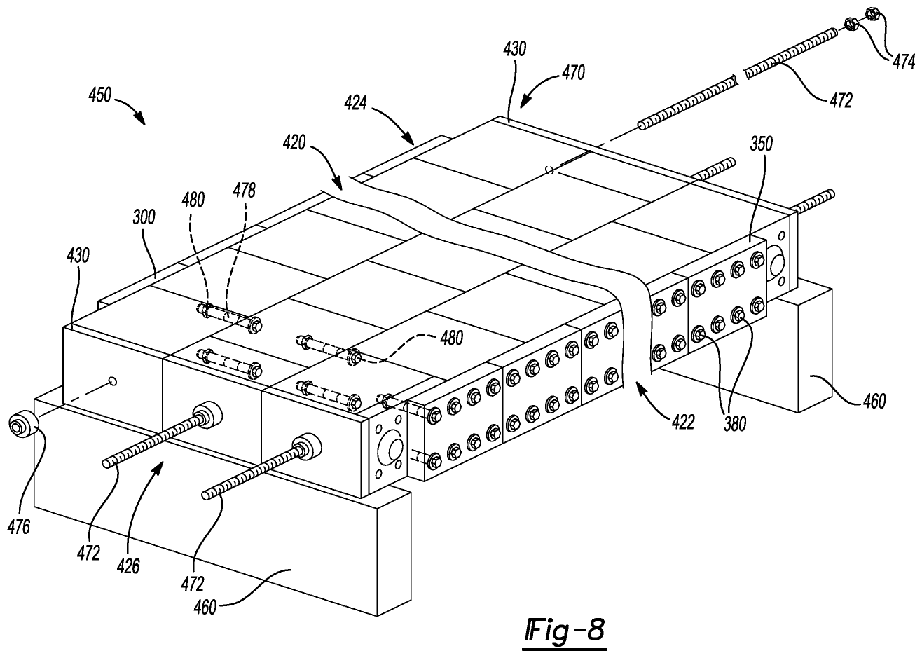

FIGS. 5 and 8 shows a completed assembly of the modular building system 400 in FIG. 4 that forms a load-bearing structure in the form of a bridge 450. The bridge 450 is disposed on an elevated support 460 and thus raised up from the ground. The bridge 450 includes the plurality of the first elements 200, the plurality of the second elements 250, the plurality of the male components 300 and the plurality of the female components 350. As best seen in FIGS. 6-8, the bridge 450 also includes the plurality of end plates 430 both on the first terminal end 426 of the bridge (FIG. 6), as well as on an opposite second terminal end 470 (FIG. 7). A first plurality of tensioners or prestressing bars 472 are disposed in the one or more openings 432. In one example, the prestressing bars 472 may include bolts formed of a steel, such as a Grade 5 steel with a tensile strength of 827 MPa. The bolts may measure 12.7 mm in nominal diameter and 88.9 mm in length. A first plurality of fastening components, such as nuts 474 are disposed on each bolt 472. Other components may also form part of the fastening components, such as washers, lock washers, and the like. As shown, two nuts 474 are fastened to the ends of the prestressing bars 472. On the first terminal end 426, a plurality of load cells 476 may be disposed on the tensioning component or prestressing bar 472. In this manner, the tensioning component or prestressing bar 472 in the end plate 430 are threaded through the central region 420 via the openings 212 or 262 of first elements 200 or second elements 250 and thus extend across many respective components to achieve a predetermined level of prestress or tensioning on the load-bearing structure.

As partially shown in FIG. 8, a second plurality of fastening components, such as bolts 478, can be disposed in respective apertures 224 or 228 of the first elements 200, apertures 274 or 278 of the second elements 250, apertures 330 of the male plate component 300, or apertures 380 of the female plate component 350 to couple and connect respective elements in the assembly via dry joints capable of being disassembled. The bolts 478 can be secured by nuts 480. Other components may also form part of the fastening components, such as washers, lock washers, and the like. As will be appreciated, while only partially shown, these fasteners 478 may optionally be present between various pairs of respective elements in the load-bearing structure.

### EXAMPLE

In this example, a modular building system provided by certain aspects of the present disclosure is used to create a load-bearing bridge structure. To resist various loads during construction and operation of structures, a bendable concrete is used to fabricate the elements. Preliminary designs of elements are presented based on the bendable concrete. Bendable concrete is chosen as the material for the elements due to its damage tolerant behavior under concentrated loads, making the resulting elements jointable by steel nuts and bolts without suffering from brittle fracture.

More specifically, the bendable concrete, also known as Engineered Cementitious Composites (ECC), is a mixture prepared using ASTM Type I Portland cement, Class F fly ash, finely ground quartz sand, polyvinyl alcohol (PVA) fibers, and tap water. The quartz sand has an average diameter of 75 μm and a density of 2.63 g/cm³. The PVA fibers are 8 mm in length, 39 μm in diameter, and 1,300 kg/m³ in density; the tensile strength, Young's modulus, and ultimate elongation of the PVA fibers are 1.6 GPa, 43 GPa and 6%-8%, respectively. In the mixture, the water-to-binder ratio is 0.25; the sand-to-binder ratio is 0.36; the PVA fiber volume percentage is 2% by the volume of the concrete. The binder is composed of 30% cement and 70% fly ash, by mass. A high range water reducer is used at a dosage of 0.1% by volume of the binder to make the mixture self-consolidating.

The mixture is mixed using a 60-Qt. (57-L) Hobart mixer. First, the cement, fly ash, and quartz sand are mixed in dry condition at 60 rpm for 5 min. Then, the high range water reducer is dissolved in water and introduced to the mixer, and mixed at 120 rpm for 5 min. Finally, the PVA fibers are manually added at 60 rpm in 2 min, followed by mixing at 120 rpm for 3 min. On completion of mixing, the mixture is checked by hand, and no fiber agglomeration is found.

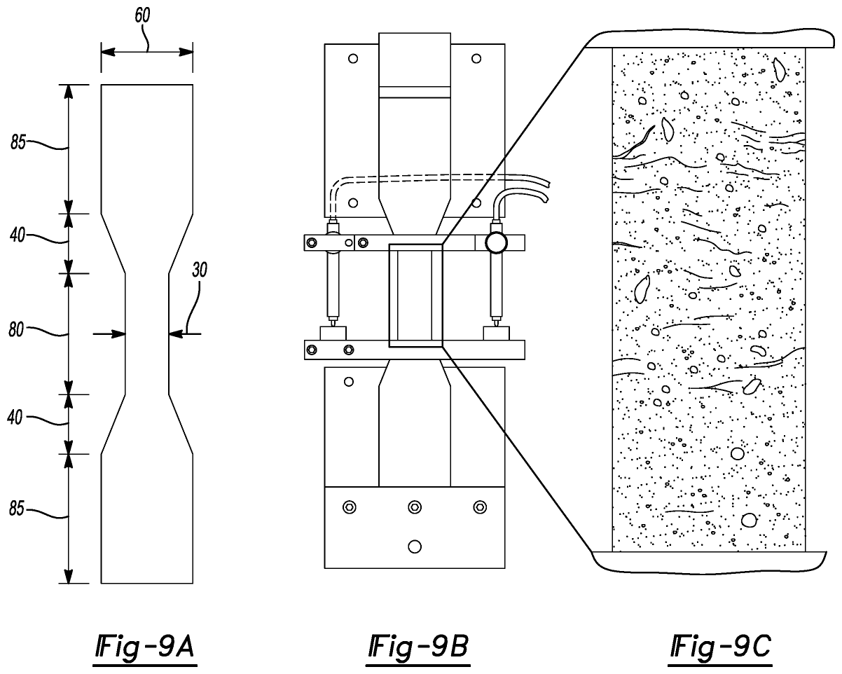

The compressive strength is determined using 50-mm cubes in accordance with ASTM C 109. Three samples are replicated in each test. The loading rate is maintained at 1.8 kN/min until failure. The compressive strength is 46 MPa±2 MPa. Four dog-bone specimens shown in FIG. 9A are tested under tension at a displacement rate of 0.05 mm/min. In FIG. 9A, dimensions of the dog-bone specimens are shown in mm. A thickness of the dog-bone (in a dimension not shown) is about 13 mm. FIGS. 9B and 9C show the testing device and a cross-sectional view of the specimen tested.

The applied load and specimen elongation within the 80-mm gauge length are measured using an embedded load cell in the testing device and two external linear variable differential transformers, respectively. Tensile stress-strain curves are formed. The mixtures have a tensile strength of 5.8 MPa±0.2 MPa and an ultimate strain of 4.6%±0.3%.

The bendable concrete is a version of Engineered Cementitious Composite (ECC) featured with high tensile ductility. Typically, the tensile strain corresponding to the peak tensile stress is higher than 4%, which is more than 400 times that of conventional concrete. Once cracked, conventional concrete fails to resist tensile force, while ECC maintains resistance to tensile force. Compared with fiber-reinforced concrete, ECC exhibits strain-hardening behavior, which means that the tensile stress continues increasing with the tensile strain after initial microcracking. The unique tension resistance of ECC makes it an attractive structural material for resistance to seismic loading, impact loading, and bolting or anchoring force.

A footbridge is formed from reusable damage-tolerant load-bearing elements as part of a modular building system, like that shown and described in the context of FIGS. 4-5 and tested. Here, the elements are fabricated through casting with customized molds, although may be formed by additive manufacturing. The use of molds leads to additional costs of materials and time for the fabrication of the elements, because of the need to prepare the molds, demold, and clean the molds. In this example, the footbridge is simply supported on rigid supports with a span length of 2.8 m. The bridge is designed to resist its self-weight and the action of two adults walking through the bridge. Structural analysis of the bridge is performed using finite element models established using the software ABAQUS. The elements are modeled using eight-node solid elements (C3D8R). The material properties obtained from the material testing are adopted in the finite element model. Surface-to-surface hard contact is defined for each pair of contacted surfaces. Through the influence line analysis, the most undesired loading scenario is determined—applying the pedestrian load at the mid-span of the bridge. According to the finite element analysis, under the combination of self-weight and pedestrian load, the maximum tensile stress in the bendable concrete of the bridge is 4 MPa, which is close to the first crack strength. The various elements will be reused after the structure is disassembled. Thus, the structure is designed to be free of cracking under design operation loads. To avoid cracking, post-tensioned bars are used to apply prestressing forces.

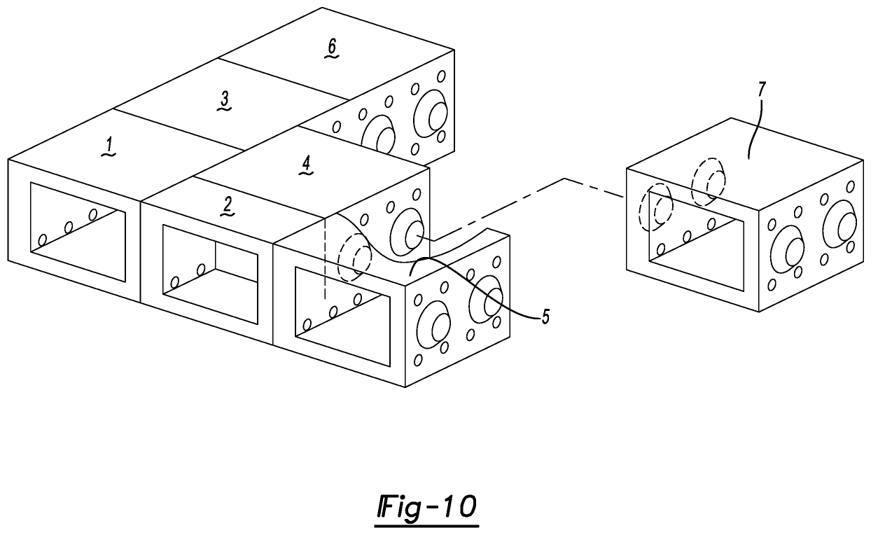

The construction process of the footbridge is divided into three main steps: (1) assembling the prefabricated elements, (2) applying prestressing force, and (3) lifting and placing the bridge on supports. FIG. 10 depicts the assembling sequence, with the respective numbers representing the placement order (so that 1 is placed first, 2 is placed second, and the like). During assembling, the elements are laid on a flat surface in the laboratory; adjacent elements are connected via the shear keys and bolts. A torque wrench is used to apply a consistent torque (55 N·m) to each set of the bolt and washers (e.g., a steel bolt, two washers, and one lock washer), ensuring tight dry joints between the elements and appropriate local stresses in the concrete near the bolts. The torque value is determined through a finite element analysis.

Considering possible interference of the forces in different bolts on adjacent elements, the bolting forces are monitored using a torque wrench to ensure that all the bolts are tight. After all the elements are installed, three threaded bars are passed through the hollow section to apply prestressing forces (such as 472 shown in FIGS. 5 and 8). The tensile strength of the bars is 414 MPa. Each bar has a nominal diameter of 12.7 mm. At each end of the footbridge, three steel plates or end plates 430 are used to anchor the three threaded bars on the elements. The area of the steel plates fits the section of the elements, and the plate thickness is 9.5 mm. The yielding strength of the steel is 345 MPa. The steel plates are in direct contact with the elements at the two ends of the bridge. For passing and anchoring the threaded bars, each steel plate had a hole measuring 14 mm in diameter. There is a 25.4-mm distance between the hole and the centroid of the plate. The distance created an eccentricity of the prestressing forces in the bars. The eccentricity of the forces generates additional moment in the bridge, and in turn higher compressive stresses at the bottom and lower compressive stresses at the top of the bridge. This benefited the bridge subjected to the self-weight and pedestrian loads, because both the self-weight and pedestrian loads generate tensile stresses at the bottom and compressive stresses at the top of the bridge. With the eccentricity, the bridge's mid-span section is free of tensile stress under self-weight.

At each end of a threaded bar, a washer and two nuts are used to anchor the bar on the steel plates. Two nuts are used to effectively avoid possible slipping of the nuts during application of the prestressing forces. The prestress force in each threaded bar is applied using a wrench at one end of the bridge, namely the tensioning end; the other end of the bridge is namely the anchoring end. The force in each threaded bar is monitored using a load transducer installed at the anchoring end. The load cell (as shown in FIG. 6) is placed between the steel plate and a washer. The load cell has a force measurement capacity of 44.5 kN, and a manufacturer-specified nonlinearity of 0.25% of the rated output. The prestressing forces in the three threaded bars are applied through an iterative process until the force in each bar reached 10 kN. Finally, the footbridge is lifted using a crane and placed onto two rigid steel supports.

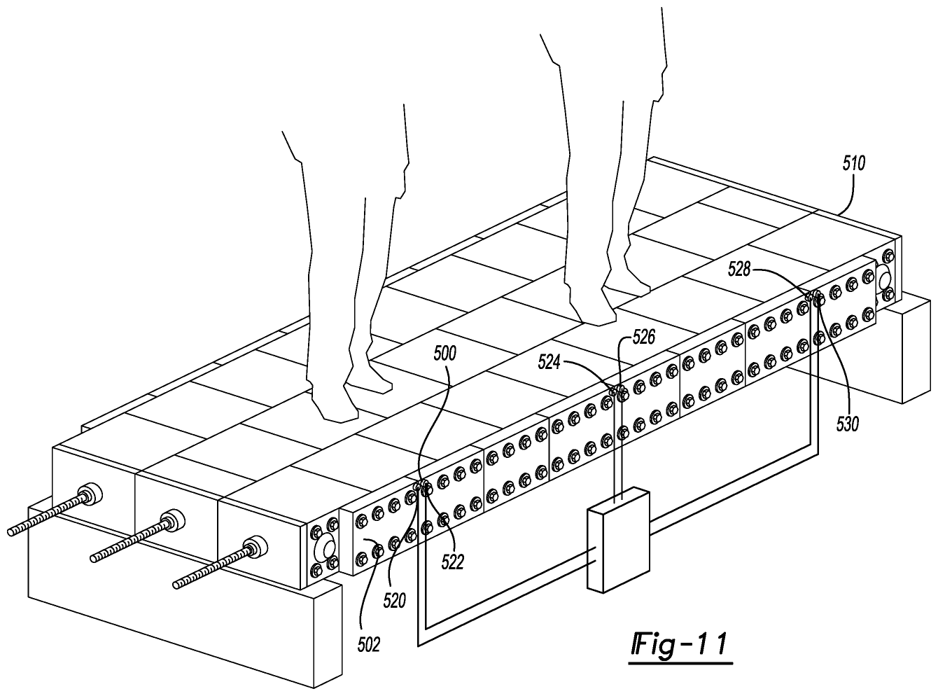

Mechanical testing is conducted to evaluate the load-carrying performance of the footbridge. In addition to the load cells that measure the forces in the threaded bars, the deformations of the bridge are monitored using an optical tracking system, which uses a camera to measure three-dimensional motions and a plurality of motion sensors 500 attached on a surface 502 of a footbridge, as depicted in FIG. 11. Compared with the conventional displacement sensors, such as linear variable differential transformers, the optical tracking system provides noncontact displacement measurements in three dimensions with a measurement accuracy of 0.001 mm. This example uses six motion sensors 500 attached on the side surfaces of the bridge. The six sensors are designated as 520-530. The optical tracking system measured the three-dimensional deformations of the bridge at the three sections where the motions sensors are deployed.

After the bridge is erected, a 150-kg steel element is placed at the middle span of the bridge as a pre-load for examining the responses of the bridge under mechanical loading, before any pedestrian load is applied. According to the measurement from the motion sensors 526 and 528, the bridge's mid-span vertical deflection due to the placement of the steel element is less than 1 mm, consistent with the prediction from the finite element analysis. According to the finite element analysis, as the applied mass is increased from 150 kg to 450 kg, the bridge does not have any damage, meaning that the bridge can carry the steel element with a dynamic factor of 3.0 (=450 kg/150 kg). Typically, the dynamic factor of moving load on a simply supported bridge is less than 2. The pre-load test and the finite element analysis suggest that it is safe to conduct the pedestrian loading test. Finally, pedestrian loading is applied. Two adults walked through the bridge at normal walking speeds (approximately 1.4 m/s). The total weight of the two adults is about 150 kg. The mid-span vertical deflection due to the pedestrian load is less than 1/2000 of the span length. Throughout the testing, no cracks due to the mechanical loading are observed. The bridge demonstrates reasonable load-carrying capability and stiffness. In other words, under combined self-weight and pedestrian loading, the maximum deflection is less than 1/2000 of the span length, and no visible crack is observed.

After the above testing, the bridge is lifted and placed on the floor using the crane. Due to dry joints, the elements can be disassembled. The bridge is disassembled following the sequence opposite to that in the assembling process. After disassemblage, the bridge's elements are visually examined, with emphasis on the joints subjected to relatively high stresses in the assembling process and the mechanical testing. No visible crack is observed. Minor chipping is observed at the edges and corners of the elements, likely caused during the transportation of the elements.

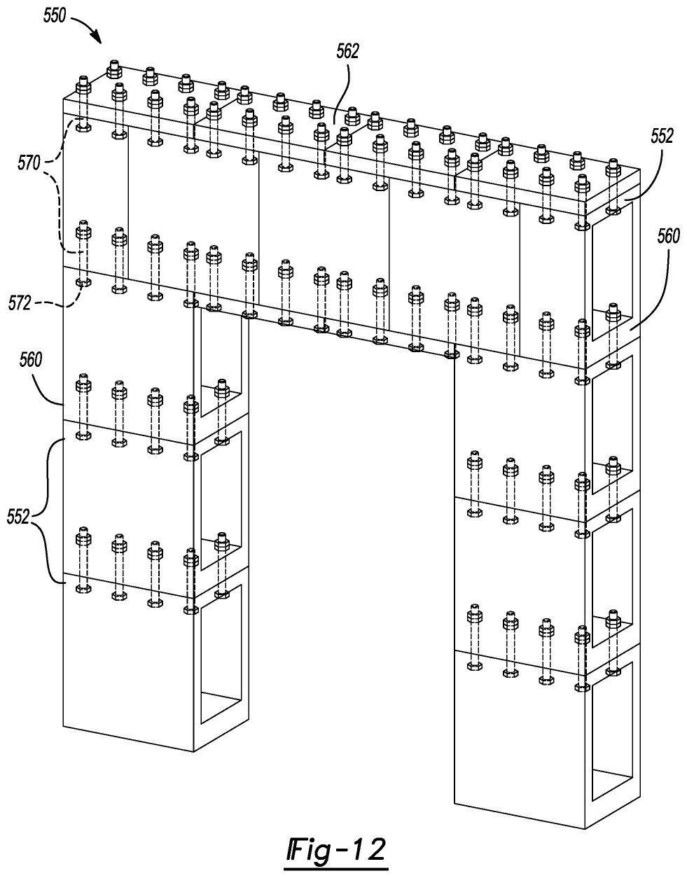

To demonstrate the reconfigurability of the elements, a plurality of elements 552 from the footbridge are reused to assemble a scaled-down frame 550, as shown in FIG. 12. The frame is composed of two columns 560 and one beam 562, mimicking a part of the frame in buildings. Compared with the footbridge, the frame 550 uses the same elements 552 connected through the shear keys and steel bolts 570 and nuts 572 (only partially shown between respective elements). As will be appreciated, while only partially shown, these bolts 570 and nuts 572 may be present between various pairs of respective elements in the load-bearing structure. More elements 552 can be added to the frame 550 following the same assembling pattern to scale up the frame and form the main structure of the frame for the multi-story building. For the purpose of demonstration, the frame 550 is assembled using the elements 552 is only subjected to self-weight. No additional mechanical loading or prestressing force is applied in this study. In real applications, post-tensioned prestressing bars or tendons can be applied to enhance the load-carrying capacity if needed, depending on the structural analysis results.

In this feasibility study, the elements are manually assembled and disassembled for the purpose of demonstration. With one person, the assembly operations of the footbridge took about 10 hours, and the disassembly operations took about 4 hours. The assembly operations took longer time than the disassembly operations, mainly because of the iterations in applying and checking the torque in each bolt. There is no need for such iterations in the disassembly process. The assembling and disassembling operations can be performed using robotic systems that can significantly improve the construction efficiency. Placement of the elements and installation of the bolts can be conducted by construction robots with high precision. The robots can use images or videos from cameras to locate objects, and use robotic arms to tighten or loosen the bolts. The forces in the bolts can be measured by torque transducers in the robotic arm, and the measured bolt force can be used to control the robotic arms. According to the existing practices of construction robots, it is envisioned that the assembly process of the footbridge will take less than 1 hour by using robotic systems in the future.

The preliminary design of the elements is used to test the feasibility. The size of elements is determined to fit for manual operation by a single person. For industrial applications, the design of the elements can be determined through an optimization process considering multiple aspects. First, structures can be assembled using limited types of standard elements and a limited number of special elements. Second, the design of the elements must ensure appropriate mechanical performance of the assembled structures, such as the load-carrying capacity, seismic resistance, fatigue resistance, and the like. Third, the elements may be designed to be compatible with payload limits of robotic systems for digital construction. The elements can be assembled and disassembled using construction robots for high construction efficiency and quality control.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of forming a load-bearing structure comprising:
forming the load-bearing structure by placing a first reusable load-bearing element adjacent to a second reusable load-bearing element, so that the first reusable load-bearing element is fixed with respect to the second reusable load-bearing element without adhesive or mortar, wherein the first reusable load-bearing element and the second reusable load-bearing element respectively have a compressive strength of greater than or equal to about 25 MPa.

2. The method of claim 1, wherein the placing is an automated process.

3. The method of claim 1, wherein the load-bearing structure is a civil infrastructure component.

4. The method of claim 1, wherein the load-bearing structure is selected from the group consisting of: a building, a bridge, a roadway, a runway, a retaining wall, a sound barrier wall, a hydraulic structure, a tunnel, and combinations thereof.

5. The method of claim 1, wherein the forming further comprises coupling the first reusable load-bearing element to the second reusable load-bearing element after the placing.

6. The method of claim 5, wherein the coupling comprises mechanically fastening the first reusable load-bearing element to the second reusable load-bearing element.

7. The method of claim 1, wherein the load-bearing structure is a first load-bearing structure and the method further comprises dissembling the load-bearing structure and forming a second load-bearing structure from at least one of the first reusable load-bearing element and the second reusable load-bearing element.

8. The method of claim 1, wherein the first reusable load-bearing element and the second reusable load-bearing element each comprise a cementitious material substantially free of any metal reinforcement components.

9. The method of claim 1, wherein the load-bearing structure is substantially free of any metal reinforcement components.

10. The method of claim 1, wherein after forming, the load-bearing structure is tensioned with a tensioning component that is capable of disassembly.

11. The method of claim 1, wherein the first reusable load-bearing element and the second reusable load-bearing element are a portion of a plurality of reusable load-bearing elements that are assembled to form the load-bearing structure.

12. The method of claim 1, further comprising forming the first reusable load-bearing element and the second reusable load-bearing element by additive manufacturing with a printable cementitious composition having a fresh state and a hardened state, wherein in the fresh state the printable cementitious composition is flowable and extrudable in the additive manufacturing process and in the hardened state, the printable cementitious composition exhibits strain hardening, wherein the composition comprises Portland cement, a calcium aluminate cement, a fine aggregate, water, a high range water reducing agent (HRWRA), and a polymeric fiber.

13. The method of claim 11, wherein the first reusable load-bearing element and the second reusable load-bearing element respectively have a hardened state with a compressive strength at 28 days of greater than or equal to about 25 MPa.

14. The method of claim 11, wherein the first reusable load-bearing element and the second reusable load-bearing element have a uniaxial tensile strength of greater than or equal to about 2.5 MPa and a tensile strain capacity of greater than or equal to about 1%.

15. The method of claim 11, wherein the forming further comprises depositing the printable cementitious composition in a fresh state by passing the printable cementitious composition through an aperture to deposit the cementitious composition onto a target, wherein in the fresh state the composition is flowable and extrudable and after the depositing, the cementitious composition forms a hardened state exhibiting a uniaxial tensile strength of greater than or equal to about 2.5 MPa, a tensile strain capacity of greater than or equal to about 1%, and a compressive strength at 100 hours of greater than or equal to about 20 MPa.

16. The method of claim 1, wherein the first reusable load-bearing element and the second reusable load-bearing element comprise an engineered geopolymer composite cementitious composition comprising fly ash, a fine aggregate, sodium silicate (Na₂SiO₃), sodium hydroxide (NaOH), a polymeric fiber, and water.

17. The method of 16, wherein the engineered geopolymer composite cementitious composition comprises the fine aggregate present at greater than or equal to about 17 to less than or equal to about 22 mass % of the cementitious composition, the fly ash present at greater than or equal to about 50 to less than or equal to about 60 mass % of the cementitious composition, water is present at greater than or equal to about 7 to less than or equal to about 12 mass % of the cementitious composition, the polymeric fiber is present at greater than or equal to about 0.7 to less than or equal to about 1.5 mass % of the cementitious composition, sodium silicate (NaSiO₃) present at greater than or equal to about 10 to less than or equal to about 15 mass % of the cementitious composition, and sodium hydroxide (NaOH) present at greater than or equal to about 2.5 to less than or equal to about 3.5 mass % of the cementitious composition.

18. The method of claim 1, wherein the first reusable load-bearing element and the second reusable load-bearing element respectively have at least one dimension that is greater than or equal to about 1 meter.

19. The method of claim 1, wherein the first reusable load-bearing element and the second reusable load-bearing element respectively have a first dimension of greater than or equal to about 0.3 meters (about 1 foot), a second dimension of greater than or equal to about 1 meter (about 3 feet), and a third dimension of greater than or equal to about 2 meters (about 6 feet).

20. The method of claim 1, wherein the first reusable load-bearing element comprises a first mechanical interlock feature and the second reusable load-bearing element comprises a second mechanical interlock feature, wherein the first mechanical interlock feature is configured to be complementary to the second mechanical interlock feature.

21. The method of claim 1, wherein at least one of the first reusable load-bearing element and the second reusable load-bearing element comprises an integrally formed feature.

22. The method of claim 1, wherein the load-bearing structure has a lifetime of greater than or equal to about 50 years in an external environment.

23. The method of claim 1, further comprising disassembling the first reusable load-bearing element and the second reusable load-bearing element and reassembling the first reusable load-bearing element and the second reusable load-bearing element without adhesive or mortar to form a second distinct load-bearing structure.

24. A modular building system comprising:
a first reusable load-bearing component comprising a first cementitious composition and having at least one first interlock feature defining either a protrusion or a recess and at least one first aperture defined through a first wall;
a second reusable load-bearing component comprising a second cementitious composition and having at least one second interlock feature complementary to the first interlock feature having the other of the protrusion or the recess and at least one second aperture defined through a second wall, wherein the first wall and the second wall are adjacent to one another so that the at least one first interlock feature seats against the second interlock feature; and
a fastener disposed in the first aperture and the second aperture that secures the first reusable load-bearing component and the second reusable load bearing component together without any adhesive or mortar.

25. The modular building system of claim 24, wherein the first reusable load-bearing component and the second reusable load-bearing component respectively have a compressive strength of greater than or equal to about 25 MPa.

26. The modular building system of claim 24, wherein the first reusable load-bearing component and the second reusable load-bearing component have a uniaxial tensile strength of greater than or equal to about 2.5 MPa and a tensile strain capacity of greater than or equal to about 1%.

27. The modular building system of claim 24, wherein the first cementitious composition and the second cementitious composition comprise Portland cement, a calcium aluminate cement, a fine aggregate, water, a high range water reducing agent (HRWRA), and a polymeric fiber.

28. The modular building system of claim 27, wherein each respective first cementitious composition and second cementitious composition comprises the Portland cement at greater than or equal to about 25 mass % to less than or equal to about 40 mass % of the total mass of the cementitious composition, calcium aluminate cement at greater than or equal to about 1 mass % to less than or equal to about 4 mass % of the total mass of the cementitious composition, the fine aggregate at greater than or equal to about 18 mass % to less than or equal to about 35 mass % of the total mass of the cementitious composition, water at greater than or equal to about 18 mass % to less than or equal to about 30 mass % of the total mass of the cementitious composition, the high range water reducing agent (HRWRA) at greater than or equal to about 0.2 mass % to less than or equal to about 0.6 mass % of the total mass of the cementitious composition, and the polymeric fiber is present at greater than or equal to about 0.7 mass % to less than or equal to about 2.1 mass % of the total mass of the cementitious composition.

29. The modular building system of claim 27, wherein the fine aggregate comprises sand having an average particle size of less than or equal to about 2 mm.

30. The modular building system of claim 27, wherein the polymer fiber comprises polyvinyl alcohol (PVA).

31. The modular building system of claim 27, wherein the polymer fiber has a length of greater than or equal to about 5 mm to less than or equal to about 20 mm.

32. The modular building system of claim 27, wherein the first cementitious composition and the second cementitious composition further comprise one or more of: fly ash, silica flour, microsilica, attapulgite nanoclay, and hydroxypropylmethyl cellulose (HPMC).

33. The modular building system of claim 27, wherein each respective first cementitious composition and second cementitious composition comprises Portland cement at greater than or equal to about 25 mass % to less than or equal to about 40 mass % of the total mass of the cementitious composition, calcium aluminate cement at greater than or equal to about 1 mass % to less than or equal to about 4 mass % of the total mass of the cementitious composition, the fine aggregate at greater than or equal to about 18 mass % to less than or equal to about 38 mass % of the total mass of the cementitious composition, water at greater than or equal to about 18 mass % to less than or equal to about 35 mass % of the total mass of the cementitious composition, the high range water reducing agent (HRWRA) at greater than or equal to about 0.2 mass % to less than or equal to about 0.6 mass % of the total mass of the cementitious composition, the polymeric fiber at greater than or equal to about 0.7 mass % to less than or equal to about 2.2 mass % of the total mass of the cementitious composition, fly ash at greater than or equal to about 5 mass % to less than or equal to about 15 mass % of the total mass of the cementitious composition, silica flour at greater than or equal to about 0.1 mass % to less than or equal to about 5.0 mass % of the total mass of the cementitious composition, microsilica at greater than or equal to about 2.0 mass % to less than or equal to about 8.0 mass % of the total mass of the cementitious composition, attapulgite nanoclay at greater than or equal to about 0.1 mass % to less than or equal to about 5.0 mass % of the total mass of the cementitious composition, hydroxypropylmethyl cellulose (HPMC) at greater than or equal to about 0.05 mass % to less than or equal to about 0.5 mass % of the total mass of the cementitious composition.

34. The modular building system of claim 24, wherein each respective first cementitious composition and second cementitious composition comprises an engineered geopolymer composite cementitious composition comprising a fly ash, a fine aggregate, sodium silicate (Na₂SiO₃), sodium hydroxide (NaOH), a polymeric fiber, and water.

35. The modular building system of claim 34, wherein the engineered geopolymer composite cementitious composition comprises the fine aggregate present at greater than or equal to about 17 to less than or equal to about 22 mass % of the cementitious composition, the fly ash present at greater than or equal to about 50 to less than or equal to about 60 mass % of the cementitious composition, water is present at greater than or equal to about 7 to less than or equal to about 12 mass % of the cementitious composition, the polymeric fiber is present at greater than or equal to about 0.7 to less than or equal to about 1.5 mass % of the cementitious composition, the sodium silicate (NaSiO₃) present at greater than or equal to about 10 to less than or equal to about 15 mass % of the cementitious composition, and the sodium hydroxide (NaOH) present at greater than or equal to about 2.5 to less than or equal to about 3.5 mass % of the cementitious composition.

36. The modular building system of claim 24, wherein the first reusable load-bearing component defines a rectangular prism having a hollow central region and the second reusable load-bearing component has a shape selected from the group consisting of: a rectangular prism having a hollow central region, a female plate component, a male plate component, and combinations thereof.

37. The modular building system of claim 24, wherein the first reusable load-bearing component defines a rectangular prism having a hollow central region having a first volume and the second reusable load-bearing element defines a rectangular prism having a hollow central region and a second volume smaller than the first volume.

38. The modular building system of claim 37 further comprising a third reusable load-bearing component defining a female plate component and a fourth reusable load-bearing component defining a male plate component.

39. The modular building system of claim 24, wherein the first interlock feature defines a protrusion having a truncated tapered cylinder shape and the second interlock feature defines a recess defining a complementary truncated tapered cylinder shape.

40. A load-bearing structure comprising:
a plurality of first reusable load-bearing components comprising a first cementitious composition and having at least one first interlock feature defining either a protrusion or a recess and at least one first aperture defined through a first wall;
a plurality of second reusable load-bearing components comprising a second cementitious composition and having at least one second interlock feature complementary to the first interlock feature having the other of the protrusion or the recess and at least one second aperture defined through a second wall, wherein the first wall and the second wall are adjacent to one another so that the at least one first interlock feature seats against the second interlock feature; and
a plurality of fasteners respectively disposed in the first aperture and the second aperture that secures each of the first reusable load-bearing component and the second reusable load bearing components together without any adhesive or mortar.

41. The load-bearing structure of claim 40 selected from the group consisting of: a building, a bridge, a roadway, a runway, a retaining wall, a sound barrier wall, a hydraulic structure, a tunnel, and combinations thereof.

42. The load-bearing structure of claim 40, wherein the plurality of first reusable load-bearing component and the plurality of second reusable load-bearing components respectively have a compressive strength of greater than or equal to about 25 MPa.

43. The load-bearing structure of claim 40, wherein the plurality of first reusable load-bearing components and the plurality of second reusable load-bearing components respectively have a uniaxial tensile strength of greater than or equal to about 2.5 MPa and a tensile strain capacity of greater than or equal to about 1%.

44. The load-bearing structure of claim 40, wherein the first cementitious composition and the second cementitious composition comprise Portland cement, a calcium aluminate cement, a fine aggregate, water, a high range water reducing agent (HRWRA), and a polymeric fiber.

45. The modular building system of claim 40, wherein the first cementitious composition and second cementitious composition comprise a fly ash, a fine aggregate, sodium silicate (Na₂SiO₃), sodium hydroxide (NaOH), a polymeric fiber, and water.

46. The load-bearing structure of claim 45, wherein the plurality of first reusable load-bearing components defines a rectangular prism having a hollow central region and the plurality of second reusable load-bearing components respectively have a shape selected from the group consisting of: a rectangular prism having a hollow central region, a female plate component, a male plate component, and combinations thereof.

47. The load-bearing structure of claim 40, wherein the plurality of first reusable load-bearing components each defines a rectangular prism having a hollow central region having a first volume, the plurality of second reusable load-bearing components each defines a rectangular prism having a hollow central region and a second volume smaller than the first volume, and the load-bearing structure further comprises a plurality of third reusable load-bearing components defining a female plate component, and a plurality of fourth reusable load-bearing components defining a male plate component.

48. The load-bearing structure of claim 40, further comprising at least one tensioning component connected to the assembly of the plurality of first reusable load-bearing components and the plurality of second reusable load-bearing components.
